(19) United States
(12) Patent Application Publication
(10) Pub. No.: US 2011/0206105 A1
(43) Pub. Date: Aug. 25, 2011

(54) METHOD FOR DETERMINING HYBRID DOMAIN COMPENSATION PARAMETERS FOR ANALOG LOSS IN OFDM COMMUNICATION SYSTEMS AND COMPENSATING FOR THE SAME

(75) Inventors: Hai Lin, Osaka (JP); Katsumi Yamashita, Osaka (JP)

(73) Assignee: OSAKA PREFECTURE UNIVERSITY PUBLIC CORPORATION, Osaka (JP)

(21) Appl. No.: 13/125,881

(22) PCT Filed: Nov. 2, 2009
(86) PCT No.: PCT/JP2009/005834

§ 371 Date: Apr. 25, 2011

(30) Foreign Application Priority Data
Nov. 1, 2008 (JP) 2008-282640

(51) Int. Cl. H04B 17/00; H04L 27/01

(52) U.S. Cl. 375/224; 375/232

(57) ABSTRACT

In a transmit/receive system, the carrier frequency offset (CFO), I/Q imbalance, and DC offset (DCO) can cause serious signal distortions. These analog losses can be compensated for individually or in combination of any two of them by following various methods that have been suggested. However, there have suggested no methods of simultaneously compensating, for these three types of losses that occur in actual devices at the same time. The present invention suggests a novel pilot signal that has a cyclic signal portion and a portion of two equally spaced continual signals. The invention provides a method for compensating for the CFO, I/Q imbalance, and DCO by simultaneously performing the time domain compensation and the channel estimation using those signal portions. The method also compensates for the I/Q imbalance and the channel response on the transmitter side in the OFDM scheme.

### TECHNICAL FIELD

The present invention relates to a method for compensating for analog loss that occurs in the transmitter, the transmission line, and the receiver in a transmit/receive system that employs the OFDM scheme. More specifically, the invention relates to a method for collectively compensating for I/Q imbalance occurring in the complex modulator of a transmitter, the channel response and the carrier frequency offset in a transmission line, and the I/Q imbalance and the DC offset occurring in the complex modulator of a receiver.

### BACKGROUND ART

Transmit/receive systems which employ the Orthogonal Frequency Division Multiplex (hereinafter referred to as the “OFDM”) in direct conversion transceivers suffer from degradation in transmission performance due to analog losses such as the carrier frequency offset, the transmitter/receiver I/Q imbalance, and the DC offset. Studies have been conducted on each of these loss factors separately.

Note that throughout this specification, the carrier frequency offset will be hereinafter referred to as the “CFO.” Furthermore, the I/Q unbalance that is caused by an error between the I axis side circuit and the Q axis side circuit of a complex modulator will be referred to as the “I/Q imbalance.” Note that the I/Q imbalance on the transmitter side will be called “TIQI,” while the I/Q imbalance on the receiver side will be called “RIQI.” Additionally, the DC offset will be referred to as the “DCO.” Finally, the frequency-dependent loss that occurs in the transmission line will be called the “channel response.”

Various wireless communication standards, such as the DVB, the IEEE 802.11, and the wireless USB, employ the OFDM scheme. The most significant defect of the OFDM is sensitive to the CFO. On the other hand, recent strong demands for lower costs of reception terminals stimulate the use of the direct conversion transceiver (DCT). Although the DCT has tremendous merits in terms of cost and power consumption, it causes other analog losses typified by the aforementioned DC offset (DCO) and I/Q imbalance.

The DCO is caused by the self-mixing of the receiver. On the other hand, the I/Q imbalance is caused in both the transmitter and the receiver by such circuit components or local oscillators that do not ideally work. Typically, the I/Q imbalance is classified according to the frequency characteristic.

For example, the local oscillator (or Local Oscillation, hereinafter referred to as the “LO”) imbalance is caused by imperfect 90-degree phase shifts and respective unequal gains of I/Q. The LO unbalance is not dependent of the frequency but constant across a signal band.

In contrast to this, the unbalance caused by a circuit component that is not consistent with the frequency response is naturally frequency selective. In the OFDM system, these sorts of analog losses lead to various types of degradation in performance (see Patent Literature 5).

In addition to those mentioned above, a number of studies conducted on the CFO and the frequency independent I/Q imbalance have been presented. In Non-Patent Literatures 1 to 3, there is suggested a method for compensating for the CFO in the receiver and the two types of I/Q imbalance, assuming that no I/Q imbalance is present in the transmitter. Furthermore, in Non-Patent Literature 4, there is provided a method for compensating for the DCO and the frequency-independent I/Q imbalance, and a joint ML (maximum likelihood) evaluation of the CFO. These Non-Patent Literatures take only one of the aforementioned analog loss factors.

### PRIOR TECHNICAL LITERATURE

### Non-Patent Literature

NON-PATENT LITERATURE 1: G. Xing, M. Shen, and H. Liu, “Frequency offset and I/Q imbalance compensation for direct-conversion receivers,” IEEE Trans. WirelessCommun., vol. 4, pp. 673-680, March 2005.
NON-PATENT LITERATURE 2: H. Lin, T. Adachi, and K. Yamashita, “Carrier frequency offset and I/Q imbalances compensation in OFDM systems,” in Proc. IEEE GLOBECOM '07, November 2007.
NON-PATENT LITERATURE 3: H. Lin, X. Zhu, and K. Yamashita, “Pilot-aided low-complexity CFO and I/Q imbalance compensation for OFDM systems,” in Proc. IEEEICC '08, May 2008.
NON-PATENT LITERATURE 4: G. Gil, I. Sohn, J. Park, and Y. H. Lee, “Joint ML estimation of carrier frequency, channel, I/Q mismatch, and DC offset in communication receivers,” IEEE Trans. Veh. Technol., vol. 54, pp. 338-349, January 2005.
NON-PATENT LITERATURE 5: E. Lopez Estraviz, S. De Rore, F. Horlin, A. Bourdoux, and L. Vander Perre, “Pilot design for joint channel and frequency-dependent transmit/receive IQ imbalance estimation and compensation in OFDM based transceivers,” in Proc. IEEE ICC '07, June 2007.

### DISCLOSURE OF THE INVENTION

### Problems to be Solved by the Invention

However, since the CFO, the DCO, and the I/Q imbalance affect each other, eliminating only one of them would not necessarily improve the performance of the system as a whole. That is, although these analog loss factors have to be collectively eliminated all at once, but such a method has never been available so far.

The present invention provides a method for compensating for all the analog loss factors in the transmit/receive system operating on the OFDM scheme, i.e., the TIQI on the transmitter side, the channel response and the CFO of the transmission line, and the RIQI and the DCO on the receiver side.

### Means for Solving the Problems

To address the aforementioned problems, the present invention suggests a hybrid domain compensation method which makes compensations in the time domain using cyclic pilot signals and in the frequency domain using pilot signals with transmitted signals known in advance on the receiver side. That is, to compensate for these analog losses, the present invention is configured to compensate signals before being DFT processed in the receiver and signals after being DFT processed, according to their respective losses.

More specifically, the invention provides a method for receiving an OFDM signal having a pilot signal formed of a cyclic signal portion and two continual pilot OFDM symbols to compensate for five types of analog losses, i.e., the TIQI, the channel response, the CFO, the RIQI, and the DCO by simultaneously performing the time domain compensation and the frequency domain compensation.

The first aspect of the present invention provides a method for analytically calculating the CFO from a received signal of the OFDM scheme and compensating for the resulting CFO, the received signal having the I/Q imbalance (TIQI) on the transmitter side, the channel response and the CFO of the transmission line, and the I/Q imbalance (RIQI) and the DCO on the receiver side. In the compensation for an analog loss that occurs in an OFDM scheme transmission line, the most critical key factor is the level of CFO (hereinafter referred to as the “amount of CFO”). Note that for this compensation purpose, such a signal is employed which is known in a time domain allotted to a pilot signal. The signal known in the time domain refers to a signal which carries a certain cyclically transmitted symbol.

The second aspect of the present invention provides a method for performing compensation on a received and then DFT processed signal using a signal which is known in the frequency domain of a pilot signal, without compensating for the RIQI and the DCO if the amount of CFO is generally zero. This is because if the CFO is generally zero, the TIQI, channel response, RIQI, and DCO can be compensated for on the DFT processed signal. Note that the signal known in the frequency domain refers to a signal carrying the transmitted information that is also known on the receiver side.

The third aspect of the present invention provides a method for compensating for the RIQI and the DCO based on the amount of CFO. As will be described later, a signal known in the time domain of a pilot signal allows the RIQI and the DCO to be represented in the form that is dependent of the amount of CFO. It is thus possible to analytically determine the RIQI and DCO using the estimated amount of CFO.

The fourth aspect of the present invention provides a method for compensating for the TIQI and channel response, on the basis of the estimated amount of CFO, using a DFT processed signal known in the frequency domain of a pilot signal with the CFO, RIQI, and DCO having been compensated for. This is because the TIQI and the channel response can be considered to be a loss that is uniquely reflected on each subchannel.

The fifth aspect of the present invention provides the structure of a pilot signal that is used for the present invention. The desirable pilot signal of the present invention has a structure that includes at least two frames: the time domain portion with predetermined symbols continually appearing for a certain length of time and an already known transmitted signal (information).

### ADVANTAGEOUS EFFECTS OF THE INVENTION

The compensation method employing the OFDM scheme of the present invention enables such compensation that takes into account all types of analog losses, such as the TIQI, channel response, and CFO on the transmission side, and the RIQI and DCO on the receiver side. As a result, even with a low SNR of a received signal, it is possible not only to ensure an error rate lower than before but also to dramatically reduce the error rate with improvements in the SNR of received signals.

Furthermore, the compensation method of the present invention can analytically determine each compensation parameter. This method can drastically reduce the amount of calculation and enable higher-speed compensations when compared with a method for calculating candidate values of parameters one after another and evaluating their validity.

Furthermore, the compensation method of the present invention can analytically compensate for the I/Q imbalance. Accordingly, even an existing system which may or may not employ the OFDM scheme is allowed to calibrate the I/Q imbalance of the receiver so long as the pilot signal has a cyclic portion.

### BRIEF DESCRIPTION OF THE DRAWINGS

FIG. 1 is a view illustrating the configuration of an OFDM scheme transmission line.

FIG. 2 is a view illustrating the structure of a pilot signal of the present invention.

FIG. 3 is a view illustrating the flow of a compensation method of the present invention.

FIG. 4 is a view illustrating the configuration of a receiver.

FIG. 5 is a view illustrating the mathematical model of a transmission line which is compensated according to the present invention.

FIG. 6 is a view illustrating the mathematical model of a compensation method of the present invention.

FIG. 7 is a view illustrating a method for sampling a time domain portion of a pilot signal.

FIG. 8 is a view illustrating another mathematical model of a compensation method of the present invention.

FIG. 9 is a view illustrating another method for sampling a time domain portion of a pilot signal.

FIG. 10 is a view illustrating the simulation results of a compensation method of the present invention.

FIG. 11 is a view illustrating the simulation results of a compensation method of the present invention.

### DESCRIPTION OF REFERENCE NUMERALS

1 signal source
2 pilot signal generator
3 synthesizer
4 frequency modulator (complex modulator)
5 antenna
5a amplifier
6 antenna
6a amplifier
7, 9 multiplier
phase converter
10, 11 low-pass filter
12, 13 switch
14 adder
15 FFT (DFT processing means)
20 time domain compensation section
21, 22 subtraction means
23 filter means
24 delay filter
25 adder
26 multiplier means 26 for multiplication by a constant λ
27 imaginary number addition means
28 multiplier
29 CFO compensation value provision means
31, 32 changeover switch
35 frequency domain compensation section
40 pilot signal
41 time domain compensation portion
42 frequency domain compensation portion
43 one set of cyclic repeats
44 cyclic prefix portion
45 one set of frequency domain
50 original signal
52 baseband signal
54 transmitted signal
56 received signal
58 baseband signal
60 received pilot signal
61 I axis signal
62 Q axis signal
63 sampling start point
65 matrix A_{O1}
65 matrix A_{Q2}
71 I axis compensated signal
72 Q axis compensated signal
73 DIQ compensated signal
74 CDIQ compensated signal
LO local oscillator

### BEST MODES FOR CARRYING OUT THE INVENTION

### First Embodiment

The present invention provides a method for compensating for the loss that an OFDM scheme signal may have when transmitted or received. In this specification, a description will be first made to the outline of a transmit/receive system and the loss that is to be compensated for according to the present invention. After that, the specification will illustrate as to how the receiver compensates for the loss. The compensation requires several compensation parameters. A description will also be made as to how to determine these parameters and how to operate on actual signals, with the OFDM signals mathematically represented. Finally, the differences between the compensation method of the present invention and the conventional compensation method will be shown by simulation.

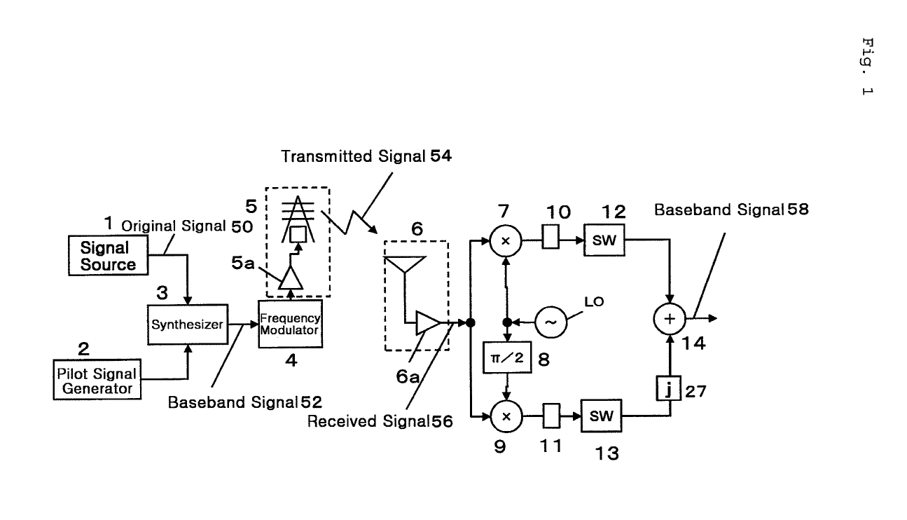

FIG. 1 is a schematic view of a transmit/receive system to be compensated according to the present invention. The descriptions below will be directed mainly to a case where the OFDM scheme is used. However, in the following descriptions, the time domain compensation is not limited to the OFDM scheme. The compensation method of the present invention can be used to compensate for the CFO, RIQI, and DCO so long as the transmit/receive system employs a pilot signal having the structure to be described later.

The transmission side includes a signal source 1, a pilot signal generator 2, a synthesizer 3, a frequency modulator 4, and a transmission antenna 5. The transmitted signal (hereinafter referred to as the “original signal 50”) is output from the signal source 1. The pilot signal produced by the pilot signal generator 2 is inserted by the synthesizer 3 into the original signal at given intervals. Note that the output from the synthesizer 3, which has already been subjected to the Inverse Discrete Fourier Transform (hereinafter referred to as the “IDFT”), is an analog signal with a subcarrier of a predetermined OFDM scheme. This will be referred to as the baseband signal 52.

This analog signal is superimposed by the frequency modulator 4 on a transmission carrier signal to yield a signal of a predetermined transmission signal band (hereinafter referred to as the “transmitted signal 54”). This signal is transmitted through an antenna 5. Note that if necessary, the strength of the signal is appropriately amplified by an amplifier 5a. Here, the frequency modulator 4 employs what is called a complex modulation circuit.

The receiver side allows a reception antenna 6 and an amplifier 6a to receive the transmitted signal 54. The received signal (hereinafter referred to as the “received signal 56”) is input to a complex demodulation circuit and then down-converted by a local oscillator LO to a baseband signal. Here, the complex demodulation circuit includes a local oscillator LO, multipliers 7 and 9, a phase converter 8, and low-pass filters 10 and 11. The branch for the multiplier 7 is referred to as the I axis path, while the branch for the multiplier 8 is referred to as the Q axis path. Furthermore, the phase converter 8 advances the phase of a signal from the local oscillator LO by π/2 and reverses the power.

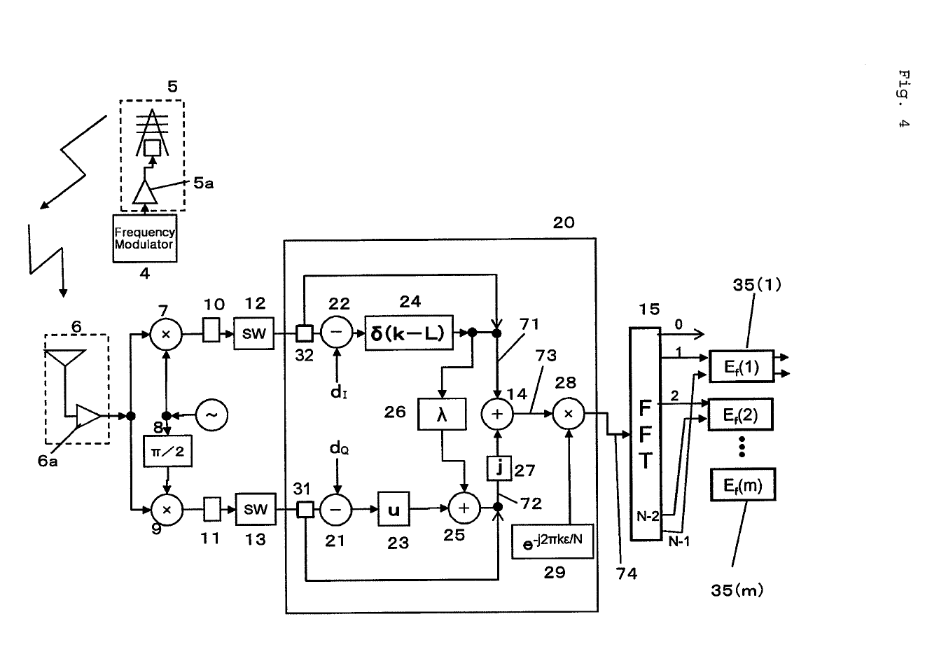

After having passed the low-pass filters 10 and 11, the I axis signal and the Q axis signal are converted into discrete signals by switches SW 12 and 13 that operate at an appropriate sampling frequency, respectively. After that, the signals are added to each other at an adder 14, thereby producing a baseband signal 58 without an image signal. This baseband signal is Discrete Fourier Transform (hereinafter referred to as the “DFT”) processed at a DFT processing section 15 (to be described referring to FIG. 4), thereby providing the original signal. Note that this specification describes, as the DFT processing, the conversion of signals from the time axis to the frequency axis; however, the Fast Fourier Transform (hereinafter referred to as the “FFT”) may also be employed for this processing.

First, the transmit/receive system operating on this OFDM scheme has the losses that can be largely divided as follows. First, the transmitter side has the I/Q imbalance (TIQI) that is occurs due to the difference in circuit characteristics between the I axis and the Q axis of the complex modulator used in the frequency modulator 4. Both the circuits on the I axis side and the Q axis side are adjusted to have the same characteristics; however, it is difficult to prepare the perfectly identical circuits. Therefore, the I/Q imbalance is an unavoidably occurring loss.

Next, while radio waves emitted from the transmitter reach a receiver, a loss, called the channel response, is generated due to geographical or spatial effects. Finally, the receiver has losses such as the I/Q imbalance (RIQI) caused by the complex demodulator in the receiver, the CFO caused by the inconsistency between the LO on the transmitter side and the one on the receiver side, and the direct current offset (DCO) that occurs due to the carrier signal being self-reproduced by the local oscillator LO.

Of these losses, the TIQI and the channel response on the transmitter side can be compensated for by receiving a pilot to signal whose information contents (the frequency of the subcarrier when transmitted) are known in advance, if the RIQI, CFO, and DCO on the receiver side have been compensated for. Therefore, compensating for these losses is referred to as the frequency domain compensation. On the other hand, if the CFO is determined to be generally zero, the frequency domain compensation can also be performed to compensate for the RIQI and DCO on the receiver side. This frequency domain compensation is performed at an equalizer 35 located at the stage downstream of the DFT processing section 15.

On the other hand, the RIQI, CFO, and DCO of the receiver, which are an analog-like loss, can be compensated for by using a cyclic pilot signal. This is because the periodicity of the signal is not affected even if the signal is subjected to losses such as the TIQI or the channel response on the transmitter side. Therefore, compensating for these losses is referred to as the time domain compensation. The time domain compensation is performed at a time domain compensation section 20 located immediately before the DFT processing section 15 on the receiver.

In a transmit/receive system operating on the OFDM scheme which has the TIQI, the channel response, and the CFO on the transmission side, and the RIQI and the DCO on the receiver 3.o side, the compensation method of the present invention compensates for all these losses.

As described above, the compensation method of the present invention is executed on the receiver. The control section (not shown) in the receiver calculates a parameter for compensation from the received pilot signal. Hereinafter, these will be collectively referred to as the compensation parameter. After a compensation parameter has been calculated, the compensation parameter is set to the time domain compensation section 20 and the equalizer 35 (to be described referring to FIG. 4) to carry out the compensation procedure. The received signal having undergone the compensation procedure has the aforementioned losses compensated for when the signal is output from the equalizer 35.

Furthermore, as can be seen from the descriptions above, in the compensation method of the present invention, the transmitter side transmits to the receiver side a pilot signal for time domain compensation and a pilot signal for frequency domain compensation.

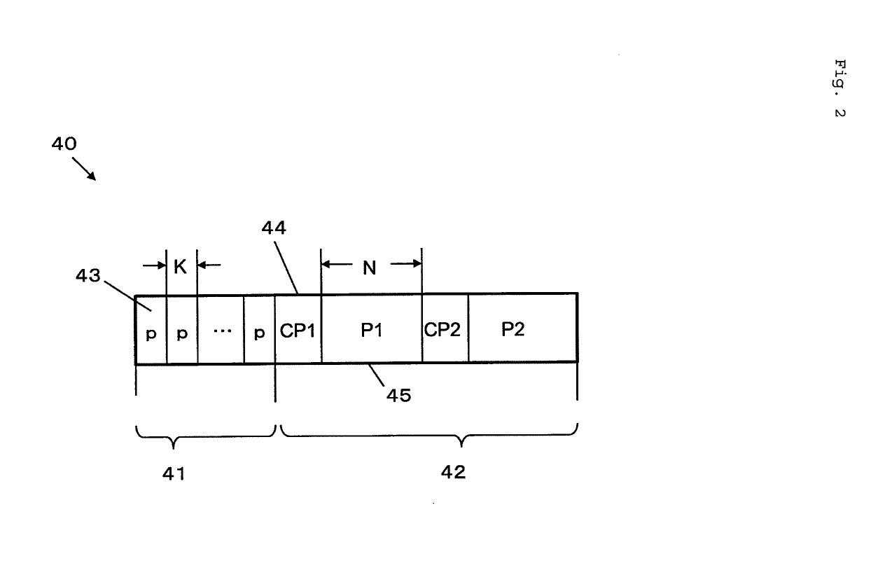

FIG. 2 illustrates the arrangement of a pilot signal to be used for the compensation method of the present invention. The compensation method of the present invention employs a pilot signal 40 that has a reference signal of a time domain compensation portion 41 and a frequency domain compensation portion 42. This is because the method requires a clue for simultaneously compensating for the aforementioned five losses.

The pilot signal to be used in the present invention includes the time domain compensation portion 41 in which a signal p43 of one set of K symbols is repeated, and the frequency domain compensation portion 42 whose transmitted information is known to the receiver in advance. The time domain compensation portion 41 can have the signal p of arbitrary contents, only requiring the set of the same K symbols to be repeated. Using this time domain compensation portion 41, at least the amount of CFO is determined. Furthermore, if the determined CFO is not zero, this portion of the pilot signal is used to determine the compensation parameter for the RIQI and the DCO on the receiver side.

The K symbols can be sufficiently repeated so as to determine the pseudo-inverse matrix from the matrix π in Equation (63) to be described later. For example, although detailed conditions will be shown later, they can be sufficiently repeated M+3 times or more, where N=KM (M is an arbitrary integer), and N is the number of subcarriers.

The frequency domain compensation portion 42 includes at least two or more frames 45. The CP1 denoted with reference numeral 44 (the same also holds for CP2) is a cyclic prefix, which can be one that is typically used with the OFDM scheme. The two frames P1 and P2 are used to transmit already known information between the transmitter and the receiver. This is because they are used to compensate for signals on the receiver side after the signals have been DFT processed. The known information for the receiver to be informed of by the transmitter may be determined when the system is set up or may be informed from the transmitter to the receiver by superimposing the information on transmissions. On the other hand, the mth signals of P1 and P2 need to differ from each other. Note that the relationship between the mth signals of the information that the P1 and P2 convey will have a more restricting condition, to be shown later, in order to facilitate the computation for compensation.

The time domain compensation portion 41 and the frequency domain compensation portion 42 can be transmitted in any order without being limited to a particular order of transmission. Furthermore, since the time domain compensation and the frequency domain compensation are performed separately, it is not necessary to send them in succession. However, as will be described later, to compensate for the aforementioned losses, the CFO is first compensated for, so that the time domain compensation portion 41 is preferably transmitted prior to the frequency domain compensation portion 42.

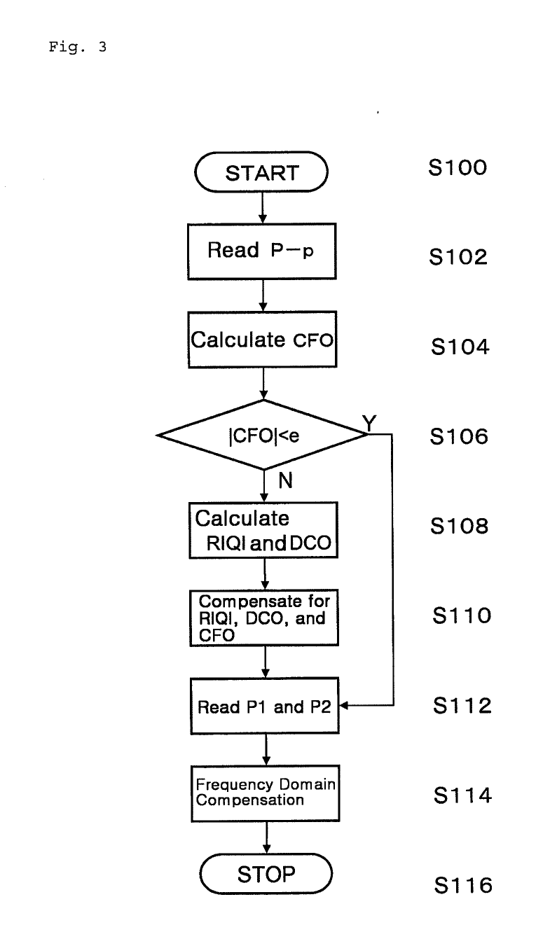

FIG. 3 illustrates the flow of a method for determining compensation parameters. The below-described flow will be followed in the control section or the like of a receiver (not shown). The flow will be mainly executed by software, but may also be done by dedicated hardware. When a compensation starts (S100), the process reads the time domain compensation portion of a pilot signal (denoted with “P-p” in the figure) (S102). Then, the read signal is used to determine the amount of CFO (S104). This is because without compensating for the CFO, other losses cannot be successfully determined.

Then, the process determines whether the absolute value of the amount of CFO is less than a predetermined value (here, let it be “e”) (S106). The “e” may be such a sufficiently small value that the CFO can be considered to be generally zero in the design of a transmit/receive system.

If the CFO cannot be considered to be generally zero (branch “N” at S106), the process determines the compensation parameters for the DCO and the receiver side RIQI on the basis of the amount of CFO (S108). These can be determined generally simultaneously. Then, the parameters to compensate for the receiver side RIQI, DCO, and CFO are set in the time domain compensation section 20 (S110). The signal to be received hereafter will have no receiver side RIQI, DCO, and CFO.

Next, the process reads the frequency domain compensation portion of a pilot signal (denoted with P1 and P2 in FIG. 3) (S112). This signal is DFT processed after the DCO, RIQI, and CFO are compensated for. Then, based on the DFT processed signal and those transmitted pieces of information (known), the process determines compensation parameters for a frequency domain compensation section 35 (S114).

Here, if the CFO is generally zero (branch “Y” at S106), the process determines compensation parameters which are used to compensate for the channel response, the transmitter side TIQI, the RIQI, and the DCO by the frequency domain compensation. Accordingly, the process skips to step 5112. As will be described later, this is because if the CFO is zero, the DCO and the receiver side RIQI can be compensated for by the frequency domain compensation after the DFT processing. On the other hand, if the CFO is not zero, the process allows a frequency compensation section 35 to determine compensation parameters including those for compensation of the channel response and TIQI. Through the steps above, the process determines the compensation parameters for use in the time domain compensation section and the frequency domain compensation section.

The determined compensation parameters are set to both is the compensation sections to compensate for all the analog losses. After the losses have been compensated for, all the signals to be subsequently received can undergo these compensations to thereby successfully recover the original signal.

FIG. 4 illustrates the complex modulator shown in FIG. 1, the time domain compensation section 20 that is subsequent to the complex modulator, and the frequency domain compensation section 35 that compensates those signals whose CFO, RIQI, and DCO have been compensated for and DFT processed by the time domain compensation section. Note that operating each compensation section requires a control section, though the control section is not shown in the figure. With reference to FIG. 4, a description will be made to the steps of compensating for received signals.

The received signal goes through the low-pass filters 10 and 11 of the I axis side and the Q axis side in the complex modulator and then the switches SW 12 and 13, which are located after the filters and operated on a certain sampling frequency, respectively. The respective signals are downconverted to the I axis side signal and the Q axis side signal, which are then converted to digital signals.

is The time domain compensation section 20 allows subtraction means 22 and 21 to compensate for the DCO by subtracting d_{I} or the amount of I axis side DCO from the I axis side signal and by subtracting d_{Q} or the amount of Q axis side DCO from the Q axis side signal, respectively. For the signal whose DCO has been compensated, the RIQI is compensated for by L-stage delay filter means 24, compensation filter means 23 having a characteristic u (represented in vector form as shown later), multiplier means 26 for multiplication by a constant λ, imaginary number addition means 27, and the adder 14.

More specifically, the process subtracts d_{I} from the I axis signal, and then delays the signal through the L-stage delay filter. The resulting signal is referred to as an I axis compensated signal 71. The I axis compensated signal is fed to the multiplier means 26 to be multiplied by λ, and sent as the real part to the adder 14. On the other hand, the process subtracts d_{Q} from the Q axis signal, and then operates a filter represented by a vector u of (2L+1) elements on the resulting signal. After that, the resulting signal is added at an adder 25 to a signal that is output from the multiplier means 26. This resulting signal is referred to as a Q axis compensated signal 72. The Q axis compensated signal 72 is sent as the imaginary part to the adder 14. The adder 14 adds the I axis signal as the real part to the Q axis signal as the imaginary part. The above processing compensates for the RIQI and DCO. The signal with the RIQI and DCO compensated for is referred to as a DIQ compensated signal 73. Note that this name may imply that the Q axis compensated signal by the imaginary number addition means is treated hereinafter as the imaginary part.

Then, the DIQ compensated signal 73 is frequency shifted by multiplier means 28 by the amount of CFO e^{-2πεk/N} to compensate for the CFO. The resulting signal is referred to as a CDIQ compensated signal 74. Reference numeral 29 refers to CFO compensation value provision means, which practically serves as a control section for outputting an analytically calculated CFO compensation value.

Once the DCO, RIQI, and CFO compensation parameters such as d_{I}, d_{Q}, vector u, constant λ, and ε are set, the time domain compensation section 20 outputs subsequent received signals with these losses compensated for.

The signal with each loss compensated for at the time domain compensation section 20 is DFT processed, and then the resulting signal undergoes compensations for the transmitter side TIQI and the channel response by the frequency domain compensation section 35. Note that if the CFO is generally zero, the receiver side RIQI and DCO are also compensated for in the frequency domain compensation section 35. FIG. 4 illustrates two processing paths; one along which a signal is sent to the adder 14 by changeover switches 31 and 32 disposed downstream of the SWs 12 and 13 without going through a delay filter 24 and the (2L+1)-stage filter u, and the other in which the CFO is generally zero. The frequency domain compensation section 35 employs two signals of each DFT processed subcarrier to perform predetermined computation processing, thereby providing a frequency domain compensated signal. This resulting signal is a signal, with each loss compensated for, located at the predetermined ordinal position in the original signal.

Note that the aforementioned compensation section is configured to represent the procedure of a compensation process, and is not necessarily limited to this configuration so long as this procedure is implemented.

Now, a description will be made in detail to a method for determining compensation parameters and a compensation method according to the present invention. As already described above, the descriptions below will employ a number of mathematical representations. In this specification, the superscript variant H, T, *, and a cross mark (dagger) represent the is Hermitian operator, the transpose matrix, the Hermitian conjugate, and the pseudo-inverse matrix, respectively. The subscript I and Q represent the real part (the I branch of the I axis path) and the imaginary part (the Q branch of the Q axis path), respectively. A character with a mark “•” on top of it will be referred to with the mark preceding that character. For example, a character “Z” with “•” placed on top of it will be written as “dot Z”. This expression will show that it is a signal that has been compensated.

In equations, the vector or matrix is represented in bold type to be distinguished from the scalar quantity. In the descriptions, characters will be preceded with a word “vector” or “matrix.” For example, a boldface letter “A” used in an equation will be referred to as “matrix A” in the description. Furthermore, the vector is defined to have one row of elements or one column of elements, whereas the matrix is defined to have a plurality of rows and columns.

The encircled “x” represents the convolution operation, F and F^{H} represents the DFT and the IDFT matrix of an N×N matrix, respectively, and a boldface 1 refers to a vector of size N×1 with all the elements being 1. More specifically, this vector is denoted with “vector 1.” Note that in this specification, the DFT and IDFT can also be referred to as the FFT and IFFT.

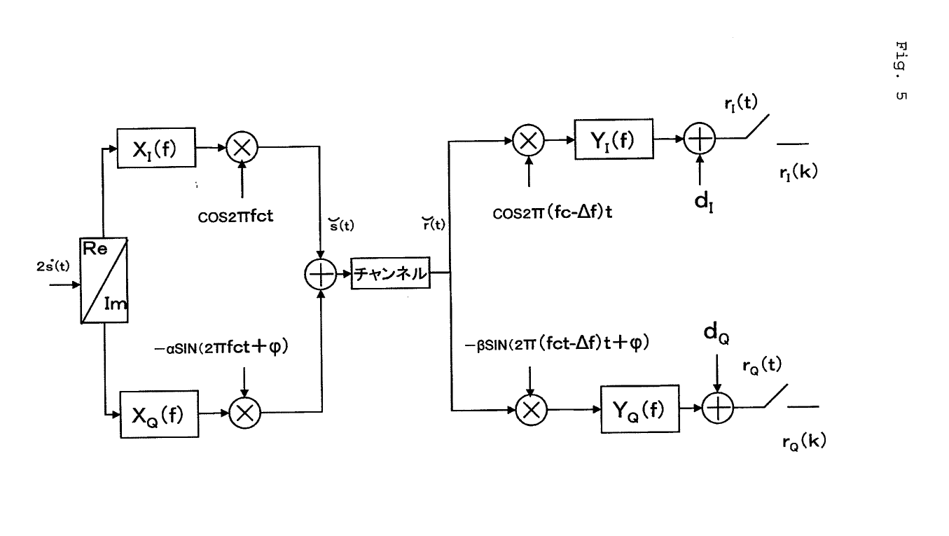

FIG. 5 illustrates a mathematical model of a transmit/receive system with analog loss. This is a representation of FIG. 1 as a mathematical model. Note that as described above, in this specification, a description will be made to a system that employs the OFDM scheme. However, the transmit/receive system of FIG. 5 is not limited to the OFDM scheme; the time domain compensation of the present invention is also applicable to any other transmit/receive schemes than the OFDM scheme.

The baseband signal to be transmitted (with reference numeral 52 in FIG. 1) or two-dot s(t) is modulated and sent by the transmitter as a transmitted signal (with reference numeral 54 in FIG. 1) or bleb s(t). Note that the baseband signal can mean a signal available immediately before being modulated, and thus the I axis signal and the Q axis signal after the low-pass filter can be referred to as the baseband signal. Furthermore, the “bleb s(t)” refers to an “s” with an arc placed above it and opened upwardly.

In the transmitter, a signal is branched into the I axis and the Q axis and multiplied by a carrier signal, so that the resulting signals are then added together into a transmitted signal. Note that this transmitter is expected to have the TIQI to occur therein. This I/Q imbalance shows that the carrier signal multiplied at the multiplier is cos 2πf_{c}t on the I axis and −α·sin(2πf_{c}t+Φ) on the Q axis. Here, f, is the carrier frequency.

The transmitted signal propagates through the space (channel). The signal is affected even during its propagation. Here, the signal is mainly affected according to the channel. Then, the signal is received in the receiver as a received signal bleb r(t) (with reference numeral 56 in FIG. 1). In the receiver, a signal is branched into the I axis and the Q axis in the complex modulator, and multiplied by a local oscillated signal (the output from LO in FIG. 1) to be downconverted.

The RIQI on the receiver side is represented by cos 2π (f_{c}−Δf)t to be multiplied by an I axis side signal and −β sin(2π(f_{c}−Δf)t+ψ) to be multiplied by a Q axis side signal. The difference between the LO of the transmitter and the LO of the receiver can cause the CFO to occur. Note that Δf represents the CFO, and fc represents the carrier frequency. After that, the signal passes through the low-pass filter. The low-pass filter has characteristics, Y_{I}(f) and Y_{Q}(f). Furthermore, in the receiver, the DCO (d_{I} and d_{Q}) occurs due to self-mixing.

As described above, FIG. 5 shows that all the analog losses that occur in the transmitter, during propagation, and in the receiver are added into r_{I}(t) and r_{Q}(t). Then, these signals are converted by the switches SW (with reference numerals 12 and 13 in FIG. 1) to digital signals, r_{I}(k) and r_{Q}(k), respectively.

Now, using these mathematical models, a description will be made to mathematical expressions of analog losses. First, the TIQI on the transmitter will be described. In the transmitter, the frequency-independent I/Q imbalance caused by the LO is characterized by the amplitude uneven α and the phase error φ. The unevenness of component characteristics in the respective IQ circuit lines can be modeled as the real low-pass filters (LPFs) having different frequency responses, X_{I}(f) and X_{Q}(f).

Note that X_{I}(f) and X_{Q}(f) are assumed to be equal to zero in the range of |f|>B/2. Here, B is the system bandwidth. Therefore, the transmitted radio frequency (RF) signal can be expressed by Equation (1) below.

$$\begin{matrix}[ Equation 1 ] & \\ \begin{matrix}\breve{s} ( t ) = 2 \cdot \{ Re \{ \dot{s} ( t ) \} ⊗ {x}_{I} ( t ) \} cos ( 2 π {f}_{c} t ) \\ = - 2 \cdot \{ Im \{ \dot{s} ( t ) \} ⊗ {x}_{Q} ( t ) \} sin ( 2 π {f}_{c} t + φ )\end{matrix} & ( 1 )\end{matrix}$$

Solving the equation in a well-known manner leads to the is equivalent baseband signal expressed by the following equation. This is the sum of the I axis signal and the Q axis signal immediately before the signals are multiplied by a carrier signal in the transmitter. Furthermore, the dot s(t) shows a loss-free original signal.

[Equation 2]

s(t)=\dot{s}(t) [symbol] x₁(t)+\dot{s}*(t) [symbol] x₂(t) (2)

Note that in the equation above, x₁(t) and x₂(t) are as follows.

$$\begin{matrix}[ Equation 3 ] & \\ {x}_{1} ( t ) = \frac{1}{2} {F}^{- 1} \{ {X}_{I} ( f ) + α {e}^{jφ} {X}_{Q} ( f ) \} & ( 3 ) \\ [ Equation 4 ] & \\ {x}_{2} ( t ) = \frac{1}{2} {F}^{- 1} \{ {X}_{I} ( f ) - {αe}^{jφ} {X}_{Q} ( f ) \} & ( 4 )\end{matrix}$$

Furthermore, the variant F⁻¹ on the left side of Equations (3) and (4) represents the Inverse Fourier Transform. With Tₛ defined as the system sampling period satisfying the Nyquist sampling, Equation (5) representing the discrete-time transmitted signal is obtained assuming that x₁(t) and x₂(t) are the interval of periods Lₓ₁Tₛ and Lₓ₂Tₛ, respectively.

[Equation 5]

s(k)=\dot{s}(k) [symbol] x₁+\dot{s}*(k) [symbol] x₂ (5)

Note that the vector x₁ and the vector x₂ are expressed respectively as below.

[Equation 6]

x₁=[x_{1,0}, . . . , x_{1,L}_{ₓ₁}−1]^{T} (6)

[Equation 7]

x₂=[x_{2,0}, . . . , x_{2,L}_{ₓ₂}−1]^{T} (7)

The loss in the receiver is expressed as follows. After having passed through a channel having a baseband impulse response 2h(t), the received RF signal can be represented as Equation (8) shown below.

[Equation 8]

\check{r}(t)=2· [symbol] e{\tilde{r}(t)e^{j2πd}^{_{c}}^{t}} (8)

Note that the tilde r(t) is a baseband representation of the received signal and satisfies the following relationship. Furthermore, the h(t) represents the channel response.

[Equation 9]

\tilde{r}(t)=s(t) [symbol] h(t) (9)

Here, β, ψ, Y_{I}(f), and Y_{Q}(f) will be used to represent the amplitude unevenness, the phase error, and the I axis and the Q axis branch filter characteristics, respectively. The complex demodulator on the receiver side is also assumed to have the frequency offset Δf as the CFO and d=d₁+jd_{Q} as the DCO. Note that here “j” represents the imaginary unit. Note that the “tilde r(t)” represents an “r” with a wavy line placed thereon.

The DCO cannot be removed by the LPF, and can thus be modeled as the term to be added after the branch filter.

Through the well-known derivation, the downconverted baseband signal can be determined as shown below.

[Equation 10]

r(t)={e^{j2πΔft}\tilde{r}(t)} [symbol] y₁(t)+{e^{-j2πΔft}\tilde{r}*(t)} [symbol] y₂(t)+d (10)

However, y₁(t) and y₂(t) can be expressed as below.

$$\begin{matrix}[ Equation 11 ] & \\ {y}_{1} ( t ) = \frac{1}{2} {F}^{- 1} \{ {Y}_{I} ( f ) + {βe}^{- jψ} {Y}_{Q} ( f ) \} & ( 11 ) \\ [ Equation 12 ] & \\ {y}_{2} ( t ) = \frac{1}{2} {F}^{- 1} \{ {Y}_{I} ( f ) = {βe}^{jψ} {Y}_{Q} ( f ) \} & ( 12 )\end{matrix}$$

Variant F⁻¹ represents the Inverse Fourier Transform. Like the low-pass filter in the transmitter, Equation (13) representing the discrete-time received signal is obtained assuming that y₁(t), y₂(t), and the channel response are the interval of periods L_{y1}Tₛ, L_{y2}Tₛ, and L_{yh}Tₛ, respectively.

[Equation 13]

r(k)={e^{j2πΔfkT}^{ₛ}\tilde{r}(k)} [symbol] y₁+{e^{-j2πΔfkT}^{ₛ}\tilde{r}*(k)} [symbol] y₂+d (13)

Note that tilde r(k), vector h, vector y₁, and vector y₂ are expressed as below.

[Equation 14]

\tilde{r}(k)=s(k) [symbol] h (14)

[Equation 15]

h=[h₀, . . . , h_{L}_{ₕ}−1]^{T} (15)

[Equation 16]

y₁=[y_{1,0}, . . . , y_{1,L}_{_{y1}}−1]^{T} (16)

[Equation 17]

y₂=[y_{2,0}, . . . , y_{2,L}_{_{y2}}−1]^{T} (17)

The OFDM signal is expressed using the matrix. In the OFDM system having N subcarriers, bandwidth B is divided into N channels at intervals of f₀=B/N. In this case, it holds that Ts=1/(Nf₀). The CFO is typically normalized so that e=Δf/f₀. Therefore, ΔfkTₛ can be replaced by εk/N. The DFT conversion having N subchannels is expressed in the matrix F as shown in Equation (18). Here, each row represents the subchannel. The first row represents a frequency zero component, i.e., a DC component. Each row has elements that are disposed so that the phase advances from left to right. The IDFT processing is the Hermitian matrix of this matrix F.

$$\begin{matrix}[ Equation 18 ] & \\ F = \frac{1}{\sqrt{N}} [ \begin{matrix}1 & 1 & … & 1 \\ 1 & {e}^{- j \frac{2 π}{N}} & … & {e}^{- j \frac{2 π ( N - 1 )}{N}} \\ ⋮ & ⋮ & ⋱ & ⋮ \\ 1 & {e}^{- j \frac{2 π ( N - 1 )}{N}} & … & {e}^{- j \frac{2 π ( N - 1 ( N - 1 )}{N}}\end{matrix} ] & ( 18 )\end{matrix}$$

The transmitted signal is modulated in block fashion via the IDFT processing section (not shown in FIG. 1) of the transmitter, and then added with the CP of a length of N_{cp} to prevent interblock interferences. This CP ensures the cyclic convolution and the orthogonality between subcarriers. In this specification, N_{cp} is assumed to have a sufficiently large size enough to accommodate a complex channel that is formed of a transceiver and a filter in a propagation channel.

Now, the vector dot S and vector dot shaded S are defined as below.

[Equation 19]

\dot{S}=[\dot{S}(0), \dot{S}(1), . . . , \dot{S}(N−1)]^{T} (19)

[Equation 20]

[symbol]

=[\dot{S}*(0), \dot{S}*(N−1), . . . , \dot{S}*(1)]^{T} (20)

Note that the dot S(m) refers to a loss-free signal that is carried on the mth subcarrier. Furthermore, the shaded dot S(m) is the Hermitian of the dot S(m). From Equation (5) above, one transmitted OFDM symbol can be expressed as an N×1 vector.

[Equation 21]

s=F [symbol] X₁\dot{S}+F [symbol] ₂ [symbol] (21)

Note that here, the vector F^{H} represents the IDFT is processing. Furthermore, the matrix X₁ and the matrix shaded X₂ are expressed as below. They correspond to x₁ and x₂ with N subchannels, respectively.

[Equation 22]

X₁=diag{X₁(0), . . . , X₁(N−1)} (22)

[Equation 23]

[symbol]

₂=diag{X₂(0), . . . , X₂(N−1)} (23)

Furthermore, the H(m) is to mean the frequency response of the mth subchannel and expressed by vector H. Using the already well-known conclusion of Non-Patent Literature 2, the received OFDM symbol can be expressed as in Equation (24).

[Equation 24]

r=Γ(ε)F [symbol] \tilde{Y}HS+Γ [symbol] (ε)F [symbol] ₂ [symbol] +d1 (24)

However, the following relationships hold true.

$$\begin{matrix}[ Equation 25 ] & \\ 𝕊 = {X}_{1} \dot{𝕊} + {X}_{2} \dot{𝕊} = {[ S ( 0 , ) , S ( 1 ) , … , S ( N - 1 ) ]}^{T} & ( 25 ) \\ [ Equation 26 ] & \\ Γ ( ɛ ) = diag \{ 1 , {e}^{j \frac{2 πɛ}{N}} , … , {e}^{j \frac{2 πɛ ( N - 1 )}{N}} \} & ( 26 ) \\ [ Equation 27 ] & \\ {\tilde{𝕐}}_{1} = diag \{ {\tilde{Y}}_{1} ( 0 ) , {\tilde{Y}}_{1} ( 1 ) , … , {\tilde{Y}}_{1} ( N - 1 ) \} & ( 27 ) \\ [ Equation 28 ] & \\ ℍ = diag \{ H ( 0 ) , H ( 1 ) , … , H ( N - 1 ) \} & ( 28 ) \\ [ Equation 29 ] & \\ {\tilde{𝕐}}_{2} = diag \{ {\tilde{Y}}_{2} ( 0 ) , {\tilde{Y}}_{2} ( 1 ) , … , {\tilde{Y}}_{2} ( N - 1 ) \} & ( 29 ) \\ [ Equation 30 ] & \\ ℍ = diag \{ {H}^{*} ( 0 ) , {H}^{*} ( N - 1 ) , … , {H}^{*} ( 1 ) \} & ( 30 ) \\ [ Equation 31 ] & \\ 𝕊 = {[ {S}^{*} ( 0 ) , {S}^{*} ( N - 1 ) , … , {S}^{*} ( 1 ) ]}^{T} & ( 31 )\end{matrix}$$

Here, the matrix tilde Y₁(m) and the matrix tilde Y₂(m) are the mth frequency response of the vector tilde y₁ and the vector tilde y₂, respectively.

$$\begin{matrix}[ Equation 32 ] & \\ {\tilde{y}}_{1} = {[ {e}^{- j \frac{2 πɛ ( {L}_{y 1} - 1 )}{N}} {y}_{1 , 0} , {e}^{j \frac{2 πɛ ( {L}_{y 1} - 2 )}{N}} {y}_{1 , 1} , … , {y}_{1 , {L}_{y 1} - 1} ]}^{T} & ( 32 ) \\ [ Equation 33 ] & \\ {\tilde{y}}_{2} = {[ {e}^{j \frac{- 2 πɛ ( {L}_{y 2} - 1 )}{N}} {y}_{2 , 0} , {e}^{j \frac{- 2 πɛ ( {L}_{y 2} - 2 )}{N}} {y}_{2 , 1} , … , {y}_{2 , {L}_{y 2} - 1} ]}^{T} & ( 33 )\end{matrix}$$

In Equation (24), the received signal expressed by the vector r is affected by the channel expressed by the “matrix H,” the filter expressed by the “matrix Y,” the effects during frequency modulation expressed by the “matrix F,” the CFO expressed by the “matrix Γ,” and the DCO expressed by “d.”

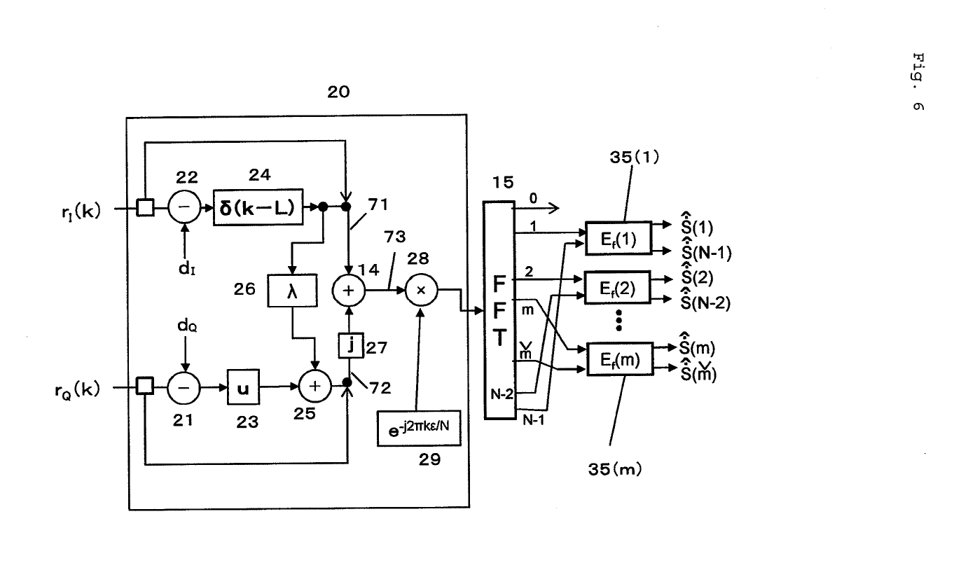

As already described above, the present invention is configured to compensate for the CFO and the receiver side RIQI and DCO in the time domain, and the transmitter side TIQI and the channel response in the frequency domain. Note that only when the CFO is generally zero, both the RIQI and DCO are also compensated for in the frequency domain. Accordingly, these are collectively referred to as a hybrid domain compensation method. The mathematical representation of the hybrid domain compensation method is shown in FIG. 6. This is generally the same as the time domain compensation section 20 and the frequency domain compensation section 35 in FIG. 4.

To begin with, a description will be made to the method for determining compensation parameters in the frequency domain. The method for determining compensation parameters will be outlined below. Assuming the CFO has been compensated for, the received signal vector r expressed by Equation (24) can be attributed to the relationship between the transmitted original signal and the signal obtained by downconverting and DFT processing the received signal.

In this context, the frequency domain portion of the pilot signal is utilized. In the frequency domain portion of the pilot signal, the receiver also knows what sort of information the transmitter has transmitted. That is, since the original signal and the received and demodulated signal are known, it is possible to determine an equalizer that cancels the relationship between those signals.

Now, a description will be made to that in detail. As described above, the CFO is assumed to have been compensated for. Then, the vector Γ(ε) and vector Γ^{H} (ε) can be eliminated from Equation (24). This is because these show the effects of the CFO.

Performing the DFT processing on the received OFDM signal or the vector r gives Equation (34).

[Equation 34]

Fr=[R(0)+d\sqrt{N}, R(1), . . . , R(N−1)]^{T} (34)

The left side of the equation above operates the matrix F on the received signal or the vector r. This shows that the received signal is subjected to the DFT processing. Note that the following relationship holds.

$$\begin{matrix}[ Equation 35 ] & \\ \begin{matrix}R ( m ) = {\tilde{Y}}_{1} ( m ) H ( m ) [ {X}_{1} ( m ) \dot{S} ( m ) + {X}_{2} ( m ) {\dot{S}}^{*} ( \breve{m} ) ] + \\ {\tilde{Y}}_{2} ( m ) {H}^{*} ( \breve{m} ) [ {X}_{1}^{*} ( \breve{m} ) {\dot{S}}^{*} ( \tilde{m} ) + {X}_{2}^{*} ( \breve{m} ) \dot{S} ( m ) ] \\ = {G}_{1} ( m ) \dot{S} ( m ) + {G}_{2} ( m ) {\dot{S}}^{*} ( \breve{m} )\end{matrix} & ( 35 )\end{matrix}$$

Here, R(m) refers to the signal that has been carried on the mth subcarrier. R(m) can be expressed as in the final equation on the right-hand side of Equation (35), where G₁(m) and G₂(m) collectively represent the transmitter side low-pass filter characteristics (X₁(m) and X₂(m)) and channel response H(m), and the receiver side low-pass filter characteristic tilde Y. However, the tick m with an inverted tick mark placed above a letter “m” is expressed as in Equation (36) below.

[Equation 36]

\check{m}=[−m]_{N} (36)

This specifies that the tick mth represents the (N−m)th for N subcarriers from 0 to N−1. That is, for example, if mth=2nd, then tick m represents the (N−2)th. However, although tick m=N when m is zero, it is to mean that this is the same as m=0. This is because the subcarriers are available up to the (N−1)th. Therefore, the tick m can also be expressed as follows under the condition that it is zero at m=0.

[Equation 37]

\check{m}[−m]_{N}=N−m (37)

Furthermore, the G₁(m) and the G₂(m) are expressed as below.

[Equation 38]

G₁(m)=\tilde{Y}₁(m)H(m)X₁(m)+\tilde{Y}₂(m)H*(\check{m})X*₂(\check{m}) (38)

[Equation 39]

G₂(m)=\tilde{Y}₁(m)H(m)X₂(m)+\tilde{Y}₂(m)H*(\check{m})X*₁(\check{m}) (39)

Based on this, Equation (35) can be reviewed to show that the loss of the signal received on the mth subcarrier has been propagated on the signal transmitted on the mth and the tick mth.

Furthermore, it holds that m=tick m for m=0 and N/2. This is because the tick m is the (N−0)th=Nth at m=0th, and the Nth means the zeroth as specified above. This is also because the tick m is (N−N/2)th=(N/2)th at m=(N/2)th. That is, this means that the signal transmitted on the zeroth and (N/2)th subcarrier has no effects on the other signals that have been transmitted on the other subcarriers. This is to say that the signals received on subcarriers other than the zeroth and the (N/2)th subcarrier are not affected by those signals carried on the zeroth and the (N/2)th subcarriers. The zeroth and the (N/2)th subcarriers correspond to the band end and the unloaded DC subcarriers.

That is, if the CFO is zero, even the DCO occurring on the receiver side does not have effects on the signals carried on other subcarriers. Furthermore, typically, the band end and the zeroth DC subcarriers are not employed for transmission of signals. Accordingly, if the CFO is generally zero, the DCO can be said not to be harmful.

For loaded subcarriers (subcarrier carrying information) other than the zeroth and the (N/2)th, the internal carrier interference (ICI) induced by the mth subcarrier due to the transmitter/receiver I/Q imbalance is related to a signal carried only on the mth and the tick mth subcarrier. Then, Equation (40) is obtained.

$$\begin{matrix}[ Equation 40 ] & \\ [ \begin{matrix}R ( m ) \\ {R}^{*} ( \breve{m} )\end{matrix} ] = [ \begin{matrix}{G}_{1} ( m ) & {G}_{2} ( m ) \\ {G}_{2}^{*} ( \breve{m} ) & {G}_{1}^{*} ( \breve{m} )\end{matrix} ] [ \begin{matrix}\dot{S} ( m ) \\ {\dot{S}}^{*} ( \breve{m} )\end{matrix} ] & ( 40 )\end{matrix}$$

Equation (40) shows that the mth subcarrier and the tick mth subcarrier constitute a small 2×2 MIMO system.

Accordingly, the I/Q imbalance compensation or an equalization of the dot S(m) and the dot S*(tick m) is attained by the equalizer matrix E_{f}(m) that corresponds to the equivalent channel matrix G(m) of Equation (40) above (the first matrix of the right-hand side in the above equation). More specifically, determining the inverse matrix of the equivalent channel matrix G(m) allows for finding the transmitted signal dot S(m) (the second term matrix on the right-hand side of Equation 40) from the received signal R(m) (the matrix on the left side of Equation 40).

However, Equation (40) does not have a sufficient number of terms enough to determine the equivalent channel matrix G(m). In this context, the two pilot signals in the frequency domain are utilized. Let the two pilot signals be P1 and P2 (see FIG. 2). Then, assume that the P1 signal carried on the mth subcarrier is S₁(m) (the Hermitian conjugate is S₁*(m)), and the received signal is R₁(m) (Hermitian conjugate is R₁*(m)). Assume also that the P2 signal to be carried on the mth subcarrier is S₂(m) (its Hermitian conjugate is S₂*(m)), and the received signal is R₂(m) (its Hermitian conjugate is R₂*(m)). Then, Equation (40) can be expressed as in Equation (41).

$$\begin{matrix}[ Equation 41 ] & \\ [ \begin{matrix}{R}_{1} ( m ) & {R}_{2} ( m ) \\ {R}_{1}^{*} ( \breve{m} ) & {R}_{2}^{*} ( \breve{m} )\end{matrix} ] = [ \begin{matrix}{G}_{1} ( m ) & {G}_{2} ( m ) \\ {G}_{2}^{*} ( \breve{m} ) & {G}_{1}^{*} ( \breve{m} )\end{matrix} ] [ \begin{matrix}{\dot{S}}_{1} ( m ) & {\dot{S}}_{2} ( m ) \\ {\dot{S}}_{1}^{*} ( \breve{m} ) & {\dot{S}}_{2}^{*} ( \breve{m} )\end{matrix} ] & ( 41 )\end{matrix}$$

to Equation (41) makes it possible to create the inverse matrix of the first term matrix on the right-hand side. The equalizer matrix E_{f}(m) is determined as below.

$$\begin{matrix}[ Equation 42 ] & \\ {E}_{f} ( m ) = {[ {[ \begin{matrix}{R}_{1} ( m ) & {R}_{2} ( m ) \\ {R}_{1}^{*} ( \breve{m} ) & {R}_{2}^{*} ( \breve{m} )\end{matrix} ] [ \begin{matrix}{\dot{S}}_{1} ( m ) & {\dot{S}}_{2} ( m ) \\ {\dot{S}}_{1}^{*} ( \breve{m} ) & {\dot{S}}_{2}^{*} ( \breve{m} )\end{matrix} ]}^{- 1} ]}^{- 1} & ( 42 )\end{matrix}$$

Here, the first matrix on the right-hand side is the matrix formed of the signal R(m) and the R*(tick m) which have been transmitted and received on the mth and tick mth subcarriers. Note that “*” means the conjugate. Likewise, the second matrix on the right-hand side is the matrix formed of the signal S(m) and the S*(tick m) which have been carried on the mth and the tick mth subcarriers. Since in the frequency domain compensation portion of the pilot signal, the transmitted mth and tick mth signals are known to the receiver, the right-hand side of Equation (42) can be calculated only from the information that the receiver can know. It is thus possible to determine the equalizer matrix E_{f}(m). Note that here, the R₁(m) and R₂(m) having the same value do not allow for determining the equalizer matrix E_{f}(m). In other words, the mth values of the pilot signals P1 and P2 have to be different from each other.

Now, a description will be made as to how the time domain compensation is applied to compensate for the I/Q imbalance, DCO, and CFO on the receiver side. This compensation can be outlined as follows.

With reference to FIG. 6, it is possible to treat the DCO as a signal to be added to the I axis signal and the Q axis signal after the low-pass filter. Referring to FIG. 6, the DCO is compensated for at once at the time domain compensation section of the receiver. Then, the I/Q imbalance of the receiver can be compensated for in the compensation circuit 20 of FIG. 6. Finally, the CFO of the signal whose DCO and RIQI have been compensated for is compensated for.

Therefore, in order to compensate for these losses, it is necessary to determine the DCO and RIQI compensation parameters (vector u and constant λ) and the value of the CFO. The present invention makes use of the time domain portion of the pilot signal to determine compensation parameters at the time domain compensation section 20. The time domain portion of the pilot signal allows signals of a length of K symbols to be repeatedly transmitted (see FIG. 2). Here, for the sake of simplicity in illustration, assume that there exists a relationship N=MK (M is an integer) where N is the number of subcarriers. As will be shown at the end of this embodiment, the relationship between the number N of sampled symbols and the number K of repeated symbols is not limited to that relationship.

is On the I axis, N samples are taken from certain symbols, and then at a point spaced apart therefrom by K symbols, additional N samples are taken. Simultaneously, on the Q axis, (N+2L) samples are taken from certain symbols, and then at a point spaced apart therefrom by K symbols, additional (N+2L) samples are taken to create a matrix. Multiple pieces of data are employed in this manner because the compensation circuit is provided with a multi-stage convolution filter as the equivalent component of a low-pass filter.

These sampled pieces of data which pass through the compensation circuit are attributed to the relationship between respective types of compensation coefficients, thus allowing each type of compensation coefficient such as the CFO, the I/Q imbalance, and the DCO to be analytically determined.

Now, a description will be made in detail to the method for determining compensation parameters in the time domain. Described first will be a case where the determined CFO is generally zero (the absolute value of the CFO is equal to or less than the predetermined value). When the CFO is generally zero, the RIQI and DCO on the receiver side needs not to be compensated for. This is because the aforementioned frequency domain compensation can be performed to demodulate the transmitted signal. First, the DCO general value is expressed by the equation below.

[Equation 43]

\hat{d}=\hat{d}_{I}+j\hat{d}_{Q} (43)

The DCO can be readily eliminated by subtracting the DCO general value from the I axis signal and the Q axis signal (see FIG. 6). The receiver side RIQI can be compensated for by the asymmetric compensation structure characterized by the well-known scalar λ described in Non-Patent Documents 1 to 3 and the FIR filter of a length of (2L+1) on the Q branch. Here, letting the discrete representation of y_{I}(t) be the vector y_{I}, the signal vector bar r affected by the CFO after the compensation for RIQI is given as in Equation (46).

[Equation 44]

y_{I}=[y_{I,0}, y_{I,1}, . . . , y_{1,L}_{_{y1}}−1]^{T} (44)

[Equation 45]

y_{I}(t)= [symbol] ⁻¹{Y_{I}(f)} (45)

[Equation 46]

r̅=Γ(ε)F [symbol] \tilde{Y}_{I}HS=Γ(ε)F [symbol] \tilde{Y}_{I}H(X₁\dot{S}+ [symbol] ₂ [symbol] ) (46)

Note that the following relationship holds.

[Equation 47]

\tilde{Y}_{I}=diag{\tilde{Y}_{I}(0), \tilde{Y}_{I}(1), . . . , \tilde{Y}_{I}(N−1)} (47)

Furthermore, the tilde Y_{I}(m) is the mth frequency response of the vector y_{I}.

$$\begin{matrix}[ Equation 48 ] & \\ {\tilde{y}}_{I} = {[ {e}^{j \frac{2 πɛ ( {L}_{yI} - 1 )}{N}} {y}_{I , 0} , {e}^{j \frac{2 πɛ ( {L}_{yI} - 2 )}{N}} {y}_{I , 1} , … , {y}_{I , {L}_{yI} - 1} ]}^{T} & ( 48 )\end{matrix}$$

It can be shown that Equation (46) representing the received signal with the DCO and RIQI compensated for is similar in shape to Equation (24) except that it is not affected by the DCO. The compensation for the CFO can be performed by a simple phase rotation, i.e., by multiplying the aforementioned vector bar r by Γ^{H}(e) from the left. It can be summarized that once the CFO is compensated for, the received signal results from the transmitted signal being affected by the losses due to the RIQI and channel response on the transmitter side and the low-pass filter characteristics on the receiver side.

Accordingly, the vector Γ^{H}(e) vector bar r is DFT processed, thereby providing the result of the same form as those of Equations (35) and (40) above. Note that the G₁(m) and G₂(m) have been changed to the tilde Y_{I}(m)H(m)X₁(m) and tilde Y_{I}(m)H(m)X₂(m), respectively. That is, if the CFO is generally zero, the signal having passed through the low-pass filter of the receiver is DFT processed, as it is, for frequency domain compensation, thereby demodulating the original signal.

Now, a description will be made to the method for calculating compensation parameters such as the d_{I}, d_{Q}, vector u, λ, and ε when the CFO is not zero. In the receiver, the signal affected by the transmission side TIQI is a signal whose characteristics such as the OFDM orthogonality has been ruined. However, the cyclic pilot signal (PP) is still cyclic. Accordingly, in the time region compensation (TDC) stage, the TIQI can be ignored by using the periodicity of pilots.

Concerning the first symbol as the cyclic prefix (CP), the received pilot sample expressed by Equation (49) is obtained when the DCO, and the RIQI and noise in the receiver are not found after a convolution having a channel of a length is shorter than K.

[Equation 49]

a(n+K)=e^{jθ}a(n),n>K (49)

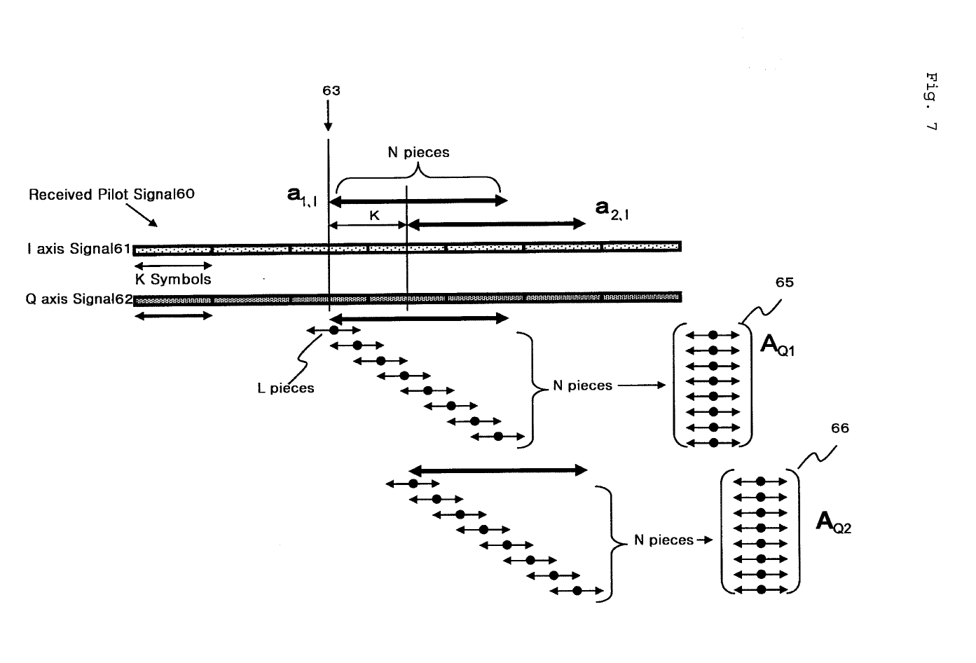

Note that θ=2πεK/N represents an unknown CFO. This shows that the nth symbol and the (n+K)th symbol in the time domain of the pilot signal have a phase difference of θ, where the CFO is ε. Then, after the DCO and RIQI have been compensated for using the structure shown in FIG. 6, (N+K) samples are acquired which satisfy Equations (50) and (51) and can be arrayed in two (N×1)-vectors. Note that here, the equations will be shown and then, referring to FIG. 7, a description will be made to a specific method for acquiring samples.

[Equation 50]

ā₁=[ā(n+L), . . . , ā(n+L+N−1)]^{T} (50)

[Equation 51]

ā₂=[ā(n+L+K), . . . , ā(n+L+N+K−1)]^{T} (51)

Furthermore, based on the relationship below, Equation (55) is obtained.

$$\begin{matrix}[ Equation 52 ] & \\ {a}_{I 1} = {[ {a}_{I} ( n ) , … , {a}_{I} ( n + N - 1 ) ]}^{T} & ( 52 ) \\ [ Equation 53 ] & \\ {A}_{Q 1} = [ \begin{matrix}{a}_{Q} ( n + L ) & … & {a}_{Q} ( n - L ) \\ {a}_{Q} ( n + 1 + L ) & … & {a}_{Q} ( n + 1 - L ) \\ ⋮ & ⋮ & ⋮ \\ {a}_{Q} ( n + N - 1 + L ) & … & {a}_{Q} ( n + N - 1 - L\end{matrix} ] & ( 53 ) \\ [ Equation 54 ] & \\ {d}_{IQ} = {d}_{Q} {\sum }_{l = 0}^{2 L} {u}_{l} + λ {d}_{I} & ( 54 ) \\ [ Equation 55 ] & \\ {\overline{a}}_{1} = {a}_{I 1} - {d}_{I } 1 + j \cdot ( {A}_{Q 1} u + λ {a}_{I 1} - {d}_{IQ} 1 ) & ( 55 )\end{matrix}$$

By substituting n+K for n, the similar result is derived with respect to the bar a₂.

$$\begin{matrix}[ Equation 56 ] & \\ {a}_{I 2} = {[ {a}_{I} ( n + K ) , … , {a}_{I} ( n + K + N - 1 ) ]}^{T} & ( 56 ) \\ [ Equation 57 ] & \\ {A}_{Q 2} = [ \begin{matrix}{a}_{Q} ( n + K + L ) & … & {a}_{Q} ( n + K - L ) \\ {a}_{Q} ( n + K + 1 + L ) & … & {a}_{Q} ( n + K + 1 - L ) \\ ⋮ & ⋮ & ⋮ \\ {a}_{Q} ( n + K + N - 1 + L ) & … & {a}_{Q} ( n + K + N - 1 - L\end{matrix} ] & ( 57 ) \\ [ Equation 58 ] & \\ {\overline{a}}_{2} = {a}_{I 2} - {d}_{I } 1 + j \cdot ( {A}_{Q 2} u + λ {a}_{I 2} - {d}_{IQ} 1 ) & ( 58 )\end{matrix}$$

Referring to FIG. 7, a description will be made in more detail as to how samples are acquired from the time domain portion of the pilot signal. The time domain portion of the pilot signal transmitted from the transmitter is affected by the transmitter side TIQI and the channel response. However, as described above, the periodicity is maintained. The pilot signal 60 received by the receiver passes through the complex demodulator and is then output after the low-pass filter of the I axis and the Q axis. FIG. 7 illustrates the I axis side signal with reference numeral 61 and the Q axis side signal with reference numeral 62.

Samples may be acquired at any start point 63. On the I axis side, N pieces of data are acquired from the acquisition start point 63. This is the vector a_{I1} in Equation (52). Furthermore, at the same time, N pieces of data are acquired again from the signal after K symbols from the start point 63. This is the vector a_{I2} in Equation (56). Of course, (N+K) symbols can be acquired from the acquisition start point 63 to create the vector a_{I1} and the vector a_{I2}.

Furthermore, in the case of the data 62 on the Q axis side, data starts to be acquired starting from the Lth symbol before the sample acquisition start point 63. From there, (N+2L) symbols are acquired and then arranged as in Equation (53) (reference numeral 65). This is a matrix A_{Q1}. (N+2L) symbols are also acquired in the same manner starting from the Lth symbol after K symbols from the acquisition start point, and then arranged as in Equation (57) (reference numeral 66). This is a matrix A_{Q2}. The acquisition start point can be located at any point so long as it is within the time domain portion of the pilot signal.

Note that (2L+1) is the number of stages of filter “u,” where L may be typically 2 to 5. Furthermore, the total number of symbols to be sampled can be any so long as it is greater than (K+L+2). As specific examples of K and L, K=16 and L=2 serve sufficiently. In general terms, as shown in FIG. 7, we seem to treat a large matrix, but in practice, only a small amount of matrix calculation is involved to achieve our purposes.

It is obvious that perfect compensation allows two vectors to satisfy the relationship given by Equation (49). Therefore, taking noise into account, the d_{I}, d_{Q}, vector u, λ, and ε can be calculated using Equation (59).

$$\begin{matrix}[ Equation 59 ] & \\ ( {\hat{d}}_{I} , {\hat{d}}_{Q} , \hat{u} , \hat{λ} , \hat{ɛ} ) = {arg min}_{{d}_{I} , {d}_{Q} , u , λ , ɛ} {‖ {\overline{a}}_{2} - {e}^{jθ} {\overline{a}}_{1} ‖}^{2} & ( 59 )\end{matrix}$$

The Equation (59) above or a cost function means that the d_{I}, d_{Q}, vector u, λ, and ε which minimize the absolute value of the right-hand side are the compensation parameters to be determined. Substituting the vector bar a₁ (Equation 50) and vector bar a₂ (Equation 51) for Equation (59) above shows that the cost function is minimized when Equations (60) and (61) below hold.

[Equation 60]

a_{I2}−a_{I1}(cos θ−λ sin θ)=−A_{Q1}u sin θ+1(d_{I}(1−cos θ)+d_{IQ} sin θ) (60)

[Equation 61]

a_{I1}−a_{I2}(cos θ+λ sin θ)=A_{Q2}u sin θ+1(d_{I}(1−cos θ)−d_{IQ} sin θ) (61)

Equation (60) and Equation (61) above can be combined into Equation (62) below.

$$\begin{matrix}[ Equation 62 ] & \\ Π [ \begin{matrix}cos θ - λ sin θ \\ cos θ + λ sin θ \\ {d}_{I} ( 1 - cos θ ) + {d}_{IQ} sin θ \\ {d}_{I} ( 1 - cos θ ) - {d}_{IQ} sin θ \\ u sin θ\end{matrix} ] = {a}_{I} & ( 62 )\end{matrix}$$

Note that the relationships below hold.

$$\begin{matrix}[ Equation 63 ] & \\ Π = [ \begin{matrix}{a}_{I 1} & 0 & 1 & 0 & - {A}_{Q 1} \\ 0 & {a}_{I 2} & 0 & 1 & {A}_{Q 2}\end{matrix} ] & ( 63 ) \\ [ Equation 64 ] & \\ {a}_{I} = [ \begin{matrix}{a}_{I 2} \\ {a}_{I 1}\end{matrix} ] & ( 64 )\end{matrix}$$

Note that vector 0 is an (N×1) zero vector. Typically, since N>2L+5, the LLS algorithm can be used to calculate the vector c for which N>(2L+5)×1 holds.

$$\begin{matrix}[ Equation 65 ] & \\ c = {Π}^{†} {a}_{I} = [ \begin{matrix}cos θ - λ sin θ \\ cos θ + λ sin θ \\ {d}_{I} ( 1 - cos θ ) + {d}_{IQ} sin θ \\ {d}_{I} ( 1 - cos θ ) - {d}_{IQ} sin θ \\ u sin θ\end{matrix} ] & ( 65 )\end{matrix}$$

The pseudo-inverse matrix of vector π (vector π dagger) and vector a_{I} are a matrix that is obtained by only those symbols sampled from the time domain portion of the pilot signal. Accordingly, the vector c can be determined only by a signal that has passed through the low-pass filter from the is complex demodulator on the receiver side. Expressing the elements of the vector c with numbers from the zeroth, c(0) and c(1) are an element of only θ, and thus θ can be determined as follows. Note that the vector u is the Q axis filter characteristics of an equivalent compensation circuit and represents a (2L+1)-stage digital filter.

[Equation 66]

\hat{θ}=arccos {0.5*(c(0)+c(1))} (66)

Hat θ is a value for determining the quantity of CFO, and a compensation by this phase angle can eliminate the CFO. Hat θ is so denoted to mean a clarified CFO. Here, it should also be noted that the hat θ is determined by the inverse cos function. Since the cos θ is an even function of θ, Equation (66) above gives only the absolute value hat θ (|hat θ|), so that if the hat θ is not zero, the CFO sign needs to be detected.

is The CFO sign is determined as follows. The samples of N symbols obtained from the time domain portion of the pilot signal are arranged in an M×K matrix that is given by Equation (67) below.

$$\begin{matrix}[ Equation 67 ] & \\ A = [ \begin{matrix}a ( n ) & … & a ( n + K - 1 ) \\ a ( n + K ) & … & a ( n + 2 K - 1 ) \\ ⋮ & ⋮ & ⋮ \\ a ( n + N - K ) & … & a ( n + N - 1 )\end{matrix} ] & ( 67 )\end{matrix}$$

Note that a(n) represents a_{I}(n)+a_{Q}(n). As in Non-Patent Literature 1, the pilot periodicity is used to obtain Equation (68) below from Equation (24) above.

[Equation 68]

A=Θ(θ)[Z^{T} [symbol] ^{T}d1_{K}]^{T} (68)

Note that vector 1_{K} represents a vector of a size of K×1 with all elements being unity. Furthermore, the matrix Θ(θ) is expressed as Equation (69).

$$\begin{matrix}[ Equation 69 ] & \\ Θ ( θ ) = [ \begin{matrix}1 & 1 & 1 \\ {e}^{j θ} & {e}^{- j θ} & 1 \\ ⋮ & ⋮ & ⋮ \\ {e}^{j ( M - 1 ) θ} & {e}^{- j ( M - 1 ) θ} & 1\end{matrix} ] & ( 69 )\end{matrix}$$

Furthermore, the vector Z and vector shaded Z are expressed as below.

[Equation 70]

Z=[z(n), . . . , z(n+K−1)] (70)

[Equation 71]

[symbol]

=[ [symbol] (n), . . . , [symbol] (n+K−1)] (71)

Equation (70) represents a pilot signal affected by the CFO, while Equation (71) represents an image replica of Equation (70). Here, the image replica or the vector shaded Z is less in power than the vector Z.

Matrix A expressed by Equation (67) is a matrix that is made up of received pilot signals. Furthermore, the matrix Θ(θ) expressed by Equation (69) is also calculated from the hat θ. Accordingly, the receiver can calculate the matrix V expressed by Equation (72).

[Equation 72]

V=Θ^{†}(|\hat{θ}|)A (72)

The matrix V represents the second matrix on the right-hand side of Equation (68). If the value of θ is positive in the second matrix on the right-hand side of Equation (68), then the power of the vector Z (the first column) is greater than the power of the vector shaded Z (the second column). That is, a comparison of power between the first column and the second column of the matrix V can determine the sign of hat θ. Specifically, if the power of the first column of the matrix V is greater than the power of the 2nd column, then the sign of θ is determined to be positive and otherwise to be negative. More specifically, it is determined whether the matrix V is the matrix V₁ or matrix V₂ as shown below.

[Equation 73]

V₁=[Z^{T} [symbol] ^{T}d1_{K}]^{T} (73)

[Equation 74]

V₂=[ [symbol] ^{T}Z^{T}d1_{K}]^{T} (74)

The matrix V can be determined from the inner product of the matrix Θ, which is expressed by Equation (69) and for which the absolute value of hat θ is substituted, and the matrix A (Equation 67) made up of symbols sampled from the time domain portion of the pilot signal. Furthermore, the power of a column in the matrix V can be determined from the sum of squares of the elements that belong to the column of interest.

Once the hat θ is determined, the other compensation parameters can be calculated by Equations (75) to (79) below using the relationship of the vector c.

$$\begin{matrix}[ Equation 75 ] & \\ \hat{λ} = 0.5 * ( c ( 1 ) - c ( 0 ) ) / sin \hat{θ} & ( 75 ) \\ [ Equation 76 ] & \\ {\hat{d}}_{I} = 0.5 * ( c ( 2 ) + c ( 3 ) ) / ( 1 - cos \hat{θ} ) & ( 76 ) \\ [ Equation 77 ] & \\ {\hat{d}}_{IQ} = 0.5 * ( c ( 2 ) - c ( 3 ) ) / sin \hat{θ} & ( 77 ) \\ [ Equation 78 ] & \\ \hat{u} = {[ c ( 4 ) , … , c ( 2 L + 4 ) ]}^{T} / sin \hat{θ} & ( 78 ) \\ [ Equation 79 ] & \\ {\hat{d}}_{Q} = \frac{2 ( c ( 2 ) - c ( 3 ) ) - ( c ( 1 ) - c ( 0 ) ) ( c ( 2 ) + c ( 3 ) )}{4 ( 1 - cos \hat{θ} ) ( c ( 4 ) + … + c ( 2 L + 4 ) )} & ( 79 )\end{matrix}$$

Once the aforementioned compensation parameters have been found, the I/Q imbalance, DCO, and CFO on the receiver side are compensated for in the configuration of the time domain compensation section 20 of FIG. 4 (or FIG. 6). Accordingly, the signals to be hereafter received by the receiver (including those in the frequency domain of the pilot signal) can be DFT processed with these losses having been compensated for, so that the equalizer matrix E_{f}(m), a relatively simple one, can be used to compensate for the I/Q imbalance and channel response on the transmitter side.

The aforementioned procedure can complete the compensation for all the analog losses in the OFDM transmission line. Note that if the amount of CFO determined by Equation (66) is generally zero (the absolute value is less than a predetermined value), then the I/Q imbalance, DCO, and CFO on the receiver side need not to be compensated for, but may be done only in the frequency domain compensation. In the above descriptions, the compensation method of the present invention has been explained in detail.

As described above, the important point in the compensation method of the present invention is that the CFO is determined from the received signal affected by an analog loss. Here, the CFO can be determined as the hat θ (Equation (66)) once the matrix c of Equation (65) is found. The condition for Equation (65) to hold is that the pseudo-inverse matrix of the matrix π in Equation (63) can be determined.

Referring to Equation (63), the elements in the first row of the matrix π show that vector a_{I1} is a longitudinally elongated N×1 vector. The same also holds true for the vector 0 and vector 1. The matrix A_{Q1} is an N×(2L+1) matrix. Furthermore, the same vector and matrix are also arranged in the second row of the matrix π. Accordingly, roughly speaking, the matrix π is a matrix that includes 2N×(2L+5) elements. For a matrix like this to have a pseudo-inverse matrix, a longitudinally elongated matrix (with the number of rows greater than the number of columns) is required.

Accordingly, the relationship of 2N>(2L+5) is needed. This condition relates to the time domain structure of the pilot signal. In this specification, for the sake of simplicity of illustration, descriptions are made assuming that N is the same as the number of subcarriers; however, the CFO is calculated with the presence of the pseudo-inverse matrix of the matrix π in Equation (63) required as an only restrictive condition.

Therefore, the relationship 2N>(2L+5) has to be maintained between the number of filter stages (2L+1) of the vector u in the time domain compensation section 20 and the number N of symbols sampled from the time domain portion of the pilot signal. Furthermore, at this time, K needs not to be limited to the relationship N=KM (here, M is any integer) as used in this specification, as long as the condition that K is less than N is satisfied.

There is also a more useful restriction concerning the frequency domain portion of the pilot signal. To determine the equalizer matrix E_{f}(m) of the frequency domain compensation section 35, it was necessary to determine the right-hand side of Equation (42). Additionally, Equation (42) cannot have a solution if the mth symbols of the pilot signals P1 and P2 are different pieces of data.

Furthermore, in general, it is known that the inverse matrix of the matrix A₁ arranged in the relationship of Equation (80) below is determined as shown in Equation (81). That is, with each element being arranged as in Equation (80), the inverse matrix can be determined readily by finding the sum of squares of the absolute value of elements “a” and “b” and then rearranging each element.

$$\begin{matrix}[ Equation 80 ] & \\ {A}_{1} = [ \begin{matrix}a & - {b}^{*} \\ b & {a}^{*}\end{matrix} ] & ( 80 ) \\ [ Equation 81 ] & \\ {A}_{1}^{- 1} = \frac{1}{{\vert a \vert}^{2} + {\vert b \vert}^{2}} [ \begin{matrix}{a}^{*} & {b}^{*} \\ - b & a\end{matrix} ] & ( 81 )\end{matrix}$$

In this context, the following relationship is established between the mth and the tick mth signals of the pilot signals P1 and P2 in the frequency domain portion. Note that here, s₀ and s₁ are each a complex number and not equal to each other. Furthermore, the mth pieces of data of P1 and P2 are represented as P1(m) and P2(m), respectively.

[Equation 82]

P₁(m)=\dot{S}(m)=s₀ (82)

[Equation 83]

P₁(\check{m})=\dot{S}₁(\check{m})=s₁* (83)

[Equation 84]

P₂(m)=\dot{S}₂(m)=−S₁* (84)

[Equation 85]

P₂(\check{m})=\dot{S}₂(\check{m})=s₀ (85)

With the pilot signal determined as described above, Equation (41) is expressed as in Equation (86) below, and moreover, Equation (42) or E_{f}(m) can be readily determined as in Equation (87).

$$\begin{matrix}[ Equation 86 ] & \\ [ \begin{matrix}{R}_{1} ( m ) & {R}_{2} ( m ) \\ {R}_{1}^{*} ( \breve{m} ) & {R}_{2}^{*} ( \breve{m} )\end{matrix} ] = [ \begin{matrix}{G}_{1} ( m ) & {G}_{2} ( m ) \\ {G}_{2}^{*} ( \breve{m} ) & {G}_{1}^{*} ( \breve{m} )\end{matrix} ] [ \begin{matrix}{s}_{0} & - {s}_{1}^{*} \\ {s}_{1} & {s}_{0}^{*}\end{matrix} ] & ( 86 ) \\ [ Equation 87 ] & \\ [ \begin{matrix}{G}_{1} ( m ) & {G}_{2} ( m ) \\ {G}_{2}^{*} ( \breve{m} ) & {G}_{1}^{*} ( \breve{m} )\end{matrix} ] = \frac{1}{{\vert {s}_{0} \vert}^{2} + {\vert {s}_{1} \vert}^{2}} [ \begin{matrix}{R}_{1} ( m ) & {R}_{2} ( m ) \\ {R}_{1}^{*} ( \breve{m} ) & {R}_{2}^{*} ( \breve{m} )\end{matrix} ] [ \begin{matrix}{s}_{0}^{*} & {s}_{1}^{*} \\ - {s}_{1} & {s}_{0}\end{matrix} ] & ( 87 )\end{matrix}$$

### Second Embodiment

FIG. 6 shows such an arrangement in which when the CFO is not zero, the receiver side RIQI and DCO, and the CFO are compensated for by disposing a delay filter on the I axis side and a (2L+1)-stage filter (matrix u) on the Q axis side. However, even when the compensations on the I axis and the Q axis are exchanged, the RIQI, DCO, and CFO can be compensated for.

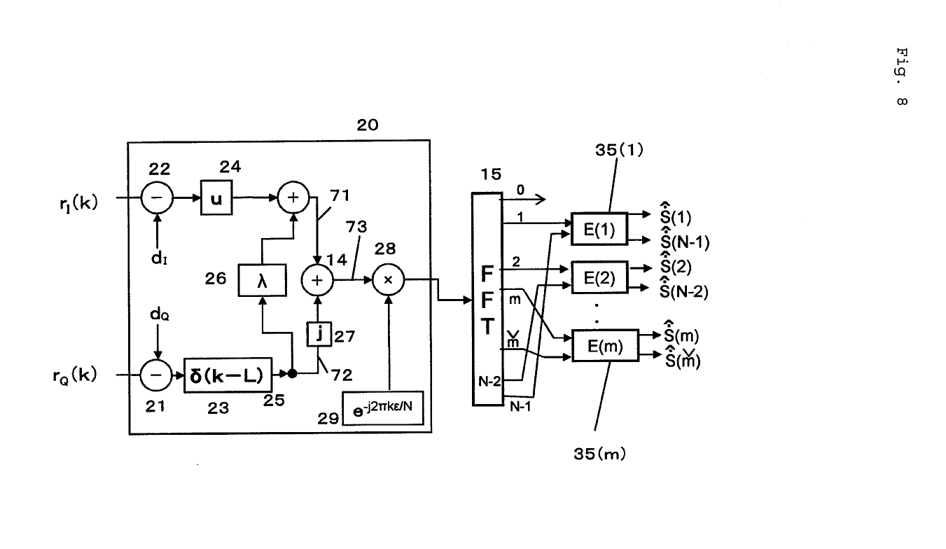

FIG. 8 illustrates the configuration of the time domain compensation section 20 to perform that compensation method. The L-stage delay filter 23 is disposed on the Q axis, and the (2L+1)-stage filter u24 is disposed on the I axis. The constant λ is added from the Q axis signal to the I axis signal. In the first embodiment, the contents described in relationship to Equations (50) through (77) are exchanged between the I axis signal and the Q axis signal. However, since the Q axis signal is different in phase from the I axis signal and treated as the imaginary number, the I axis signal and the Q axis signal in the contents of Equation (50) to Equation (77) cannot be exchanged as they are.

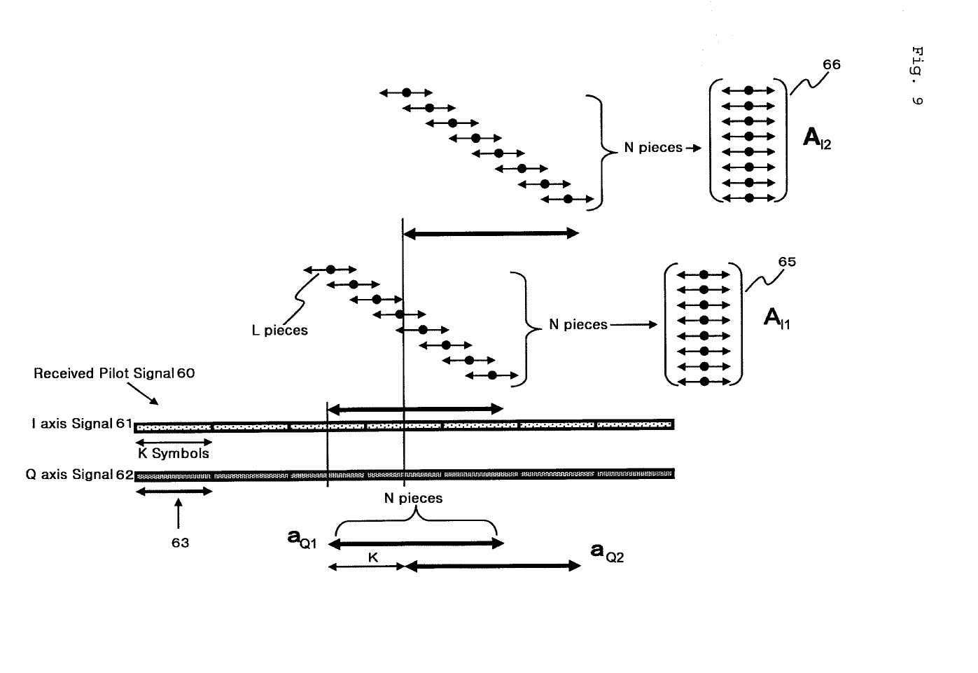

Now, a description will be made to a case where the I axis signal and the Q axis signal are exchanged. FIG. 9 illustrates the slicing of signals in the time domain of the pilot signal. N symbols are sampled starting from the sample start point 63 of the Q axis signal 62. This is the vector a_{Q1}. On the other hand, the vector a_{Q2} is created by sampling N symbols starting from the point shifted by K from the sample start point 63.

[Equation 88]

a_{Q1}=[a_{Q}(n), . . . , a(n+N−1)]^{T} (88)

[Equation 89]

a_{Q2}=[a_{Q}(n+K), . . . , a_{Q}(n+K+N−1)]^{T} (89)

Furthermore, the matrix A_{I1} is prepared by acquiring N+L symbols starting at the Lth symbol before the sampling start point to create a (2L+1)×N matrix. On the other hand, the matrix A_{I2} is prepared in the same manner by creating a (2L+1)×N matrix with the Kth symbol after the sampling start point employed as a new start point.

$$\begin{matrix}[ Equation 90 ] & \\ {A}_{I 1} = [ \begin{matrix}{a}_{I} ( n + L ) & … & {a}_{I} ( n - L ) \\ {a}_{I} ( n + 1 + L ) & … & {a}_{I} ( n + 1 - L ) \\ ⋮ & ⋮ & ⋮ \\ {a}_{I} ( n + N - 1 + L ) & … & {a}_{I} ( n + N - 1 - L )\end{matrix} ] & ( 90 ) \\ [ Equation 91 ] & \\ {A}_{I 2} = [ \begin{matrix}{a}_{I} ( n + K + L ) & … & {a}_{I} ( n + K - L ) \\ {a}_{I} ( n + K + 1 + L ) & … & {a}_{I} ( n + K + 1 - L ) \\ ⋮ & ⋮ & ⋮ \\ {a}_{I} ( n + K + N - 1 + L ) & … & {a}_{I} ( n + K + N - 1 - L )\end{matrix} ] & ( 91 )\end{matrix}$$

The DCO has been changed in the arrangement of the matrix u, and is thus represented as matrix d_{QI}.

$$\begin{matrix}[ Equation 92 ] & \\ {d}_{QI} = {d}_{I} {\sum }_{l = 0}^{2 L} {u}_{l} + λ {d}_{Q} & ( 92 )\end{matrix}$$

Then, the vector bar a₁ with the N symbols from the sampling start point 63 having been compensated for is expressed as follows.

[Equation 93]

ā₁=A_{I1}u+λa_{Q1}−d_{QI}1+j·(a_{Q1}−d_{Q}1) (93)

Furthermore, the vector bar a₂ in which the N symbols acquired starting at the Kth symbol from the sampling start point 63 have been compensated for is expressed as follows.

[Equation 94]

ā₂=A_{I2}u+λa_{Q2}−d_{Q1}1+j·(a_{Q2}−d_{Q}1) (94)

These vector bar a₁ and vector bar a₂ satisfy the relationship of Equation (49) that they are shifted by the CFO. Accordingly, in the same manner as with Equation (59), the compensation parameters can be determined.

$$\begin{matrix}[ Equation 95 ] & \\ ( {\hat{d}}_{I} , {\hat{d}}_{Q} , \hat{u} , \hat{λ} , \hat{ɛ} ) = {arg min}_{{d}_{I} , {d}_{Q} , u , λ , ɛ} {‖ {\overline{a}}_{2} - {e}^{j θ} {\overline{a}}_{1} ‖}^{2} & ( 95 )\end{matrix}$$

Substituting the vector bar a₁ and the vector bar a₂ for the above equation and reorganizing the resulting equation shows that the right-hand side of Equation (87) is minimized when the two equations below hold.

[Equation 96]

a_{Q2}−a_{Q1}(cos θ+λ sin θ)=A_{I1}u sin θ+1(d_{Q}(1−cos θ)−d_{QI} sin θ) (96)

[Equation 97]

a_{Q1}−a_{Q2}(cos θ−λ sin θ)=−A_{I2}u sin θ+1(d_{Q}(1−cos θ)+d_{QI} sin θ) (97)

Equation (96) and Equation (97) are combined into Equation (98) below.

$$\begin{matrix}[ Equation 98 ] & \\ Π [ \begin{matrix}cos θ - λsin θ \\ cos θ + λ sin θ \\ {d}_{Q} ( 1 - cos θ ) + {d}_{QI} sin θ \\ {d}_{Q} ( 1 - cos θ ) - {d}_{QI} sin θ \\ u sin θ\end{matrix} ] = {a}_{Q} & ( 98 )\end{matrix}$$

However, the matrix II and the matrix a_{Q} have the following relationships.

$$\begin{matrix}[ Equation 99 ] & \\ Π [ \begin{matrix}{a}_{Q 2} & 0 & 1 & 0 & - {A}_{I 2} \\ 0 & {a}_{Q 1} & 0 & 1 & {A}_{I 1}\end{matrix} ] & ( 99 ) \\ [ Equation 100 ] & \\ {a}_{Q} = [ \begin{matrix}{a}_{Q 1} \\ {a}_{Q 2}\end{matrix} ] & ( 100\end{matrix}$$

Letting the second term on the left-hand side in Equation (98) be the vector c, then the vector c is expressed as in Equation (101) below.

$$[ Equation 101 ]$$

$$c = {Π}^{†} {a}_{Q} = [ \begin{matrix}cos θ - λsin θ \\ cos θ + λ sin θ \\ {d}_{Q} ( 1 - cos θ ) + {d}_{QI} sin θ \\ {d}_{Q} ( 1 - cos θ ) - {d}_{QI} sin θ \\ u sin θ\end{matrix} ] \qquad ( 101 )$$

As in the first embodiment, the amount of CFO or θ can be determined from c(0) and c(1).

[Equation 102]

\hat{θ}=arccos {0.5*(c(0)+c(1))} (102)

As can be seen from Equation (102), the hat θ representative of the amount of CFO can be obtained in the same manner as in the first embodiment. The sign of the hat θ can also be determined in the same manner. This can be roughly expressed as follows.

Assume that the matrix A is a M×K matrix which is created from the received signal obtained from the time domain portion of the pilot signal.

$$\begin{matrix}[ Equation 103 ] & \\ A = [ \begin{matrix}a ( n ) & … & a ( n + K - 1 ) \\ a ( n + K ) & … & a ( n + 2 K - 1 ) \\ ⋮ & ⋮ & ⋮ \\ a ( n + N - K ) & … & a ( n + N - 1 )\end{matrix} ] & ( 103 )\end{matrix}$$

The matrix A can be rewritten as shown below.

[Equation 104]

A=Θ(θ)[Z^{T} [symbol] ^{T}d1_{K}]^{T} (104)

However, the matrix Θ(θ) is expressed as follows.

$$\begin{matrix}[ Equation 105 ] & \\ Θ ( θ ) = [ \begin{matrix}1 & 1 & 1 \\ {e}^{j θ} & {e}^{- j θ} & 1 \\ ⋮ & ⋮ & ⋮ \\ {e}^{j ( M - 1 ) θ} & {e}^{- j ( M - 1 ) θ} & 1\end{matrix} ] & ( 105 )\end{matrix}$$

Here, the matrix V is calculated as in Equation (98). If the matrix V is the matrix V₁, then θ remains as it is, whereas if the matrix V is the matrix V₂, then the sign of θ is inverted.

[Equation 106]

V=Θ^{†}(|\hat{θ}|)A (106)

[Equation 107]

V₁=[Z^{T} [symbol] ^{T}d1_{K}]^{T} (107)

[Equation 108]

V₂=[ [symbol] ^{T}Z^{T}d1_{K}]^{T} (108)

As described above, calculating the value of the CFO or θ allows for determining the compensation parameters as shown below.

$$\begin{matrix}[ Equation 109 ] & \\ \hat{λ} = 0.5 * ( c ( 1 ) - c ( 0 ) ) / sin \hat{θ} & ( 109 ) \\ [ Equation 110 ] & \\ {\hat{d}}_{I} = 0.5 * ( c ( 2 ) + c ( 3 ) ) / ( 1 - cos \hat{θ} ) & ( 110 ) \\ [ Equation 111 ] & \\ {\hat{d}}_{QI} = 0.5 * ( c ( 2 ) - c ( 3 ) ) / sin \hat{θ} & ( 111 ) \\ [ Equation 112 ] & \\ \hat{u} = {[ c ( 4 ) , … , c ( 2 L + 4 ) ]}^{T} / sin \hat{θ} & ( 112 ) \\ [ Equation 113 ] & \\ {\hat{d}}_{Q} = \frac{2 ( c ( 2 ) - c ( 3 ) ) - ( c ( 1 ) - c ( 0 ) ) ( c ( 2 ) + c ( 3 ) )}{4 ( 1 - cos \hat{θ} ) ( c ( 4 ) + … + c ( 2 L + 4 ) )} & ( 113 )\end{matrix}$$

As described above, the compensation section 20 configured as shown in FIG. 8 can also compensate for the RIQI, the DCO, and the CFO of the receiver as can be seen from above descriptions.

### EXAMPLE

The compensation method of the present invention was simulated to check the effects thereof. The OFDM system used for the simulation is similar to one in accordance with IEEE 802.11a WLAN, employing a carrier frequency of 5 GHz, B=20 MHz, N=64, and the 16 AQM signaling of N_{G1}=16. The frequency selective fading channel has three paths and an exponential attenuating power profile.

The CFO is 100 kHz, and the I/Q imbalance scenario is to such that α=0.5 dB, φ=−10 degrees, β=1 dB, and ψ=5 degrees. Note that the other conditions were given as follows.

[Equation 114]

x_{I}=[1, 0.1]^{T} (114)

[Equation 115]

x_{Q}=[1, 0.2]^{T} (115)

[Equation 116]

y_{I}=[1, −0.1]^{T} (116)

[Equation 117]

y_{Q}=[1, 0.1]^{T} (117)

The transmitted distortion-free signal is normalized to 1, in the case of which the DCO power was set as follows.

[Equation 118]

|d|²ε[0,1] (118)

Furthermore, the signal to noise ratio (SNR) was set to be 1/σ² with respect to the signal normalized to 1, while the noise variance was set to be σ².

The hybrid domain compensation method of the present invention was studied by comparison with those conventional methods of Non-Patent Literature 5 ([5]) intended only for the TIQI and RIQI, Non-Patent Literature 3 ([15]) intended only for the CFO and RIQI, and Non-Patent Literature 4 ([16]) intended only for the CFO, the frequency-independent RIQI, and the DCO. According to the suggested methods, the compensation filter length is 2 L+1=5, and the length of one pilot symbol is K=16. That is, using all the subcarriers could allow for simultaneous transmission of four pilot signals.

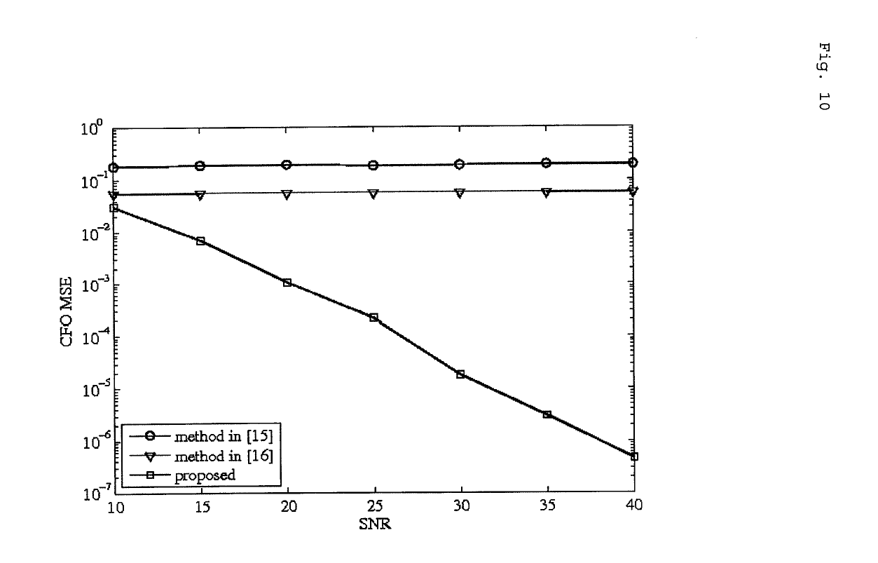

Note that the conventional methods employ unique pilots for them. FIG. 10 shows the comparison results concerning the normalized CFO square average error defined by the following equation (Equation 119). The vertical axis represents the CFO square average error, and the horizontal axis represents the signal to noise ratio (SNR). Since the conventional methods take into account only some of these analog losses, thus an effective CFO calculation value cannot be obtained even when the received signal has a higher SNR. On the other hand, the compensation method of the present invention was capable of calculating a more accurate CFO with increasing sensitivity of the received signal.

[Equation 119]

E[(ε−\hat{ε})²] (119)

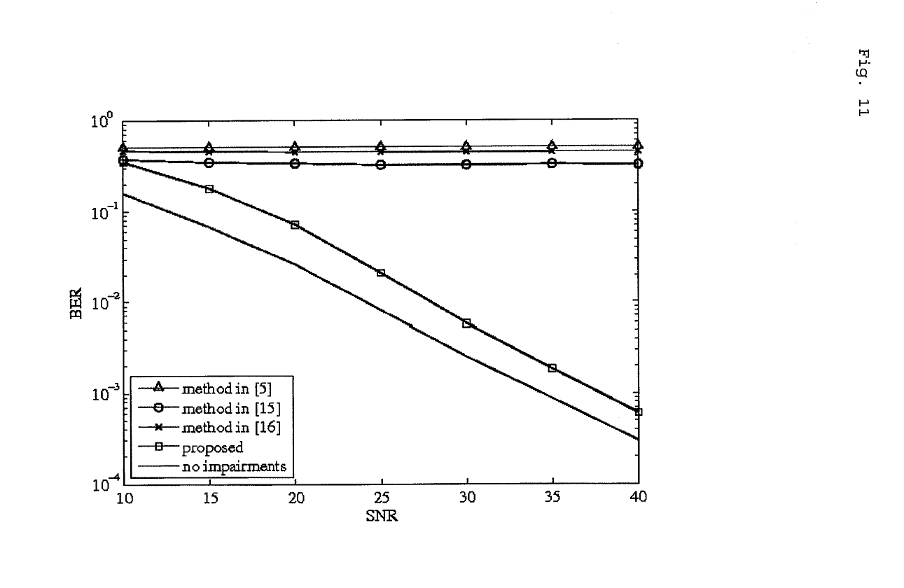

FIG. 11 shows a comparison of bit error ratio (BER) performances where the ideal case with no analog loss is displayed as a comparison reference. The vertical axis is the BER and the horizontal axis is the SNR. The conventional methods provides a constant BER value irrespective of the receive sensitivity, whereas the compensation method of the present invention can provide reduced BER as the receive sensitivity increases.

### INDUSTRIAL APPLICABILITY

The present invention is preferably applicable as a compensation method in a receiver for an OFDM transmission line. Furthermore, the present invention can employ cyclic signals to compensate for the I/Q imbalance of the complex modulator of the receiver. This makes it possible not only to receive external cyclic signals but also to automatically calibrate the complex modulator using a signal source included in the receiver.

1. A method for determining a compensation parameter, the compensation parameter compensating for a received signal having a pilot signal with a frequency domain portion in which K symbols are cyclically repeated, the method comprising the steps of:
acquiring N pieces of data starting at a sample acquisition start point in an I axis signal of the frequency domain portion to create a vector aₙ (Equation 52);
acquiring N pieces of data starting at a Kth piece of data from the sample acquisition start point in the I axis signal of the frequency domain portion to create a vector a_{I2} (Equation 56);
acquiring N+2L pieces of data starting at an Lth piece of data before the sample start point in the Q axis signal of the frequency domain portion to create a matrix A_{Q1} (Equation 53);
acquiring N+2L pieces of data starting at an (K−L)th piece of data after the sample start point in a Q axis signal of the frequency domain portion to create a matrix A_{Q2} (Equation 57);
obtaining a matrix π (Equation 63) from the vector a_{I1} (Equation 52), the vector a_{I2} (Equation 56), the matrix A_{QI} (Equation 53), the matrix A_{Q2} (Equation 57), a vector 1 with N×1 elements being all unity, and a vector 0 with N×1 elements being all zero;
obtaining a matrix a₁ (Equation 64) from the vector a_{I1} (Equation 52) and the vector a_{I2} (Equation 56);
obtaining a vector c (Equation 65) from a pseudo-inverse matrix of the matrix π (Equation 63) and the matrix a_{I} (Equation 64), where d_{I} is a real component of a DC offset (hereinafter referred to as a “DCO”) caused in a receiver and d_{Q} is an imaginary component, with the DCO being expressed as d_{IQ} (Equation 54) from a vector u of (2L+1)×1 elements and a constant λ;
determining a CFO as a hat θ (Equation 66) from a first element (c(0)) and a second element (c(1)) of the vector c,
creating a matrix A (Equation 67) of N pieces of complex data, the N pieces of complex data starting at the sample start point in the frequency domain and arranged in M rows, with K pieces of complex data per row;
determining a matrix V (Equation 72) from a pseudo-inverse matrix of a matrix Θ(θ) (Equation 69), for which an absolute value of the hat θ is substituted, and the matrix A; and
determining that the hat θ has a positive sign if a power of a first column of the matrix V (Equation 72) is greater than a power of a second column, and otherwise determining that the hat θ has a negative sign, where
$$\begin{matrix} [ Equation 200 ] & \\ {a}_{I 1} = {[ {a}_{I} ( n ) , … , {a}_{I} ( n + N - 1 ) ]}^{T} , & ( 52 ) \\ [ Equation 201 ] & \\ {a}_{I 2} = {[ {a}_{I} ( n + K ) , … , {a}_{I} ( n + K + N - 1 ) ]}^{T} , & ( 56 ) \\ [ Equation 202 ] & \\ {A}_{Q 1} = [ \begin{matrix}{a}_{Q} ( n + L ) & … & {a}_{Q} ( n - L ) \\ {a}_{Q} ( n + 1 + L ) & … & {a}_{Q} ( n + 1 - L ) \\ ⋮ & ⋮ & ⋮ \\ {a}_{Q} ( n + N - 1 + L ) & … & {a}_{Q} ( n + N - 1 - L )\end{matrix} ] , & ( 53 ) \\ [ Equation 203 ] & \\ {A}_{Q 2} = [ \begin{matrix}{a}_{Q} ( n + K + L ) & … & {a}_{Q} ( n + K - L ) \\ {a}_{Q} ( n + K + 1 + L ) & … & {a}_{Q} ( n + K + 1 - L ) \\ ⋮ & ⋮ & ⋮ \\ {a}_{Q} ( n + K + N - 1 + L ) & … & {a}_{Q} ( n + K + N - 1 - L )\end{matrix} ] , & ( 57 ) \\ [ Equation 204 ] & \\ Π [ \begin{matrix}{a}_{I 1} & 0 & 1 & 0 & - {A}_{Q 1} \\ 0 & {a}_{I 2} & 0 & 1 & {A}_{Q 2}\end{matrix} ] , & ( 63 ) \\ [ Equation 205 ] & \\ {a}_{I} = [ \begin{matrix}{a}_{I 2} \\ {a}_{I 1}\end{matrix} ] , & ( 64 ) \\ [ Equation 206 ] & \\ {d}_{IQ} = {d}_{Q} {\sum }_{l = 0}^{2 L} {u}_{l} + λ {d}_{I} , & ( 54 ) \\ [ Equation 207 ] & \\ c = {Π}^{†} {a}_{I} = [ \begin{matrix}cos θ - λsin θ \\ cos θ + λ sin θ \\ {d}_{I} ( 1 - cos θ ) + {d}_{IQ} sin θ \\ {d}_{I} ( 1 - cos θ ) - {d}_{IQ} sin θ \\ u sin θ\end{matrix} ] , & ( 65 ) \\ [ Equation 208 ] & \\ θ = arccos \{ 0.5 * ( c ( 0 ) + c ( 1 ) ) \} , & ( 66 ) \\ [ Equation 209 ] & \\ A = [ \begin{matrix}a ( n ) & … & a ( n + K - 1 ) \\ a ( n + K ) & … & a ( n + 2 K - 1 ) \\ ⋮ & ⋮ & ⋮ \\ a ( n + N - K ) & … & a ( n + N - 1 )\end{matrix} ] , & ( 67 ) \\ [ Equation 210 ] & \\ Θ ( θ ) = [ \begin{matrix}1 & 1 & 1 \\ {e}^{j θ} & {e}^{- j θ} & 1 \\ ⋮ & ⋮ & ⋮ \\ {e}^{j ( M - 1 ) θ} & {e}^{- j ( M - 1 ) θ} & 1\end{matrix} ] , and & ( 69 ) \\ [ Equation 211 ] & \\ V = {Θ}^{†} ( \vert \hat{θ} \vert ) A . & ( 72 )\end{matrix}$$

2. The method for determining a compensation parameter according to claim 1, wherein the hat θ has a sufficiently small absolute value, the pilot signal further includes at least a first frequency domain portion and a second frequency domain portion in which known data is transmitted, and the method further comprises the steps of:
DFT processing the first frequency domain portion;
determining R₁*(tick m) which is conjugate data of mth data R₁(m) and tick mth data (Equation 36) of the DFT processed data;
DFT processing the second frequency domain portion;
determining R₂*(tick m) which is conjugate data of mth data R₂(m) and tick mth data (Equation 36) of the DFT processed data; and
determining an equalizer matrix E_{f}(m) (Equation 42) from dot S₁(m), dot S₁*1 (tick m), dot S₂(m), and dot S₂*(m) which are the R₁(m), the R₁*(tick m), the R₂(m), the R₂*(tick m), and transmitted data corresponding to the data, respectively, where
$$\begin{matrix}[ Equation 212 ] & \\ \breve{m} = {[ - m ]}_{N} , and & ( 36 ) \\ [ Equation 213 ] & \\ {E}_{f} ( m ) = {[ {[ \begin{matrix}{R}_{1} ( m ) & {R}_{2} ( m ) \\ {R}_{1}^{*} ( \breve{m} ) & {R}_{2}^{*} ( \breve{m} )\end{matrix} ] [ \begin{matrix}{\dot{S}}_{1} ( m ) & {\dot{S}}_{2} ( m ) \\ {\dot{S}}_{1}^{*} ( \breve{m} ) & {\dot{S}}_{2}^{*} ( \breve{m} )\end{matrix} ]}^{- 1} ]}^{- 1} . & ( 42 )\end{matrix}$$

3. The method for determining a compensation parameter according to claim 1, the compensation parameter compensating for a received signal having a pilot signal with a frequency domain portion in which K symbols are cyclically repeated, the method further comprising the steps of: from the hat θ and the vector c,
determining a hat λ, (Equation 75),
determining a hat d₁ (Equation 76),
determining a hat d_{IQ} (Equation 77),
determining a vector hat u (Equation 78), and
determining a hat d_{Q} (Equation 79), where
$$\begin{matrix}[ Equation 214 ] & \\ \hat{λ} = 0.5 * ( c ( 1 ) - c ( 0 ) ) / sin \hat{θ} , & ( 75 ) \\ [ Equation 215 ] & \\ {\hat{d}}_{I} = 0.5 * ( c ( 2 ) + c ( 3 ) ) / ( 1 - cos \hat{θ} ) , & ( 76 ) \\ [ Equation 216 ] & \\ {\hat{d}}_{IQ} = 0.5 * ( c ( 2 ) - c ( 3 ) ) / sin \hat{θ} , & ( 77 ) \\ [ Equation 217 ] & \\ \hat{u} = {[ c ( 4 ) , … , c ( 2 L + 4 ) ]}^{T} / sin \hat{θ} , and & ( 78 ) \\ [ Equation 218 ] & \\ {\hat{d}}_{Q} = \frac{2 ( c ( 2 ) - c ( 3 ) ) - ( c ( 1 ) - c ( 0 ) ) ( c ( 2 ) + c ( 3 ) )}{4 ( 1 - cos \hat{θ} ) ( c ( 4 ) + … + c ( 2 L + 4 ) )} . & ( 79 )\end{matrix}$$

4. The method for determining a compensation parameter according to claim 2, wherein the pilot signal further includes at least a first frequency domain portion and a second frequency domain portion in which known data is transmitted, and the method further comprises the steps of:
determining a first DIQ compensation signal having a real part and an imaginary part, the real part being a first I axis compensated signal obtained by subtracting the hat d₁ from an I axis signal of the first frequency domain portion and then operating the L-stage delay filter on the resulting signal, the imaginary part being a first Q axis compensated signal obtained by subtracting the hat d_{Q} from a Q axis signal of the first frequency domain portion, operating the vector u on the resulting signal, and then multiplying the first I axis compensated signal by the hat λ;
shifting a phase of the first DIQ compensated signal by an inverted sign of the hat θ to determine a first internal interference compensation signal;
DFT processing the first internal interference compensation signal;
determining an R₁*(tick m) which is conjugate data of mth data R₁(m) and tick mth data (Equation 36) of the DFT processed data;
determining a second IQ compensation signal having a real part and an imaginary part, the real part being a second I axis compensated signal obtained by subtracting the hat d_{I} from an I axis signal of the second frequency domain portion and then operating the L-stage delay filter on the resulting signal, the imaginary part being a second Q axis compensated signal obtained by subtracting the hat d_{Q} from a Q axis signal of the second frequency domain portion, operating the vector u on the resulting signal, and then multiplying the second I axis compensated signal by the hat λ;
shifting a phase of the second IQ compensation signal by an inverted sign of the hat θ to determine a second internal interference compensation signal;
DFT processing the internal interference compensation signal;
determining R₂*(tick m) which is conjugate data of mth data R₂(m) and tick mth data (Equation 36) of the DFT processed data; and
determining an equalizer matrix E_{f}(m) (Equation 42) from dot S₁(m), dot S₁*1 (tick m), dot S₂(m), and dot S₂*(m) which are the R₁(m), the R₁*(tick m), the R₂(m), the R₂*(tick m), and transmitted data corresponding to the data, respectively, where
$$\begin{matrix}[ Equation 219 ] & \\ \breve{m} = {[ - m ]}_{N} , and & ( 36 ) \\ [ Equation 220 ] & \\ {E}_{f} ( m ) = {[ {[ \begin{matrix}{R}_{1} ( m ) & {R}_{2} ( m ) \\ {R}_{1}^{*} ( \breve{m} ) & {R}_{2}^{*} ( \breve{m} )\end{matrix} ] [ \begin{matrix}{\dot{S}}_{1} ( m ) & {\dot{S}}_{2} ( m ) \\ {\dot{S}}_{1}^{*} ( \breve{m} ) & {\dot{S}}_{2}^{*} ( \breve{m} )\end{matrix} ]}^{- 1} ]}^{- 1} . & ( 42 )\end{matrix}$$

5. A method for compensating a received signal using the hat θ determined in claim 1, the method comprising the steps of:
downconverting a received signal; and
shifting a phase of the downconverted signal by an inverted sign of the hat θ.

6. A method for compensating a received signal using the hat θ determined in claim 1 and an equalizer matrix E_{f}(m) determined, by (Equation 42) from dot S₁(m), dot S₁*1 (tick m), dot S₂(m), and dot S₂*(m) which are the R₁(m), the R₁*(tick m), the R₂(m), the R₂*(tick m), and transmitted data corresponding to the data, respectively, where
$$[ Equation 213 ]$$
$${E}_{f} ( m ) = {[ {[ \begin{matrix}{R}_{1} ( m ) & {R}_{2} ( m ) \\ {R}_{1}^{*} ( \breve{m} ) & {R}_{2}^{*} ( \breve{m} )\end{matrix} ] [ \begin{matrix}{\dot{S}}_{1} ( m ) & {\dot{S}}_{2} ( m ) \\ {\dot{S}}_{1}^{*} ( \breve{m} ) & {\dot{S}}_{2}^{*} ( \breve{m} )\end{matrix} ]}^{- 1} ]}^{- 1} \qquad ( 42 )$$
the method comprising the steps of:
determining that an absolute value of the hat θ is generally zero;
downconverting a received signal;
shifting a phase of the downconverted signal by an inverted sign of the hat θ;
DFT processing the phase shifted signal; and
obtaining a compensated signal hat dot S(m) and hat dot S(tick m) by operating the equalizer matrix E_{f}(m) on the mth and tick mth data (Equation 36) of the DFT processed data, where
[Equation 221]
\check{m}=[−m]_{N} (36).

7. A method for compensating a received signal using the hat θ determined in claim 1 and a hat λ, a hat d_{I}, a hat d_{IQ}, a vector hat u, and a hat d_{Q} determined, by
determining a hat λ (Equation 75),
determining a hat d_{I} (Equation 76),
determining a hat d_{IQ} (Equation 77),
determining a vector hat u (Equation 78), and
determining a hat d_{Q} (Equation 79), where
$$\begin{matrix}[ Equation 214 ] & \\ \hat{λ} = 0.5 * ( c ( 1 ) - c ( 0 ) ) / sin \hat{θ} , & ( 75 ) \\ [ Equation 215 ] & \\ {\hat{d}}_{I} = 0.5 * ( c ( 2 ) + c ( 3 ) ) / ( 1 - cos \hat{θ} ) , & ( 76 ) \\ [ Equation 216 ] & \\ {\hat{d}}_{IQ} = 0.5 * ( c ( 2 ) - c ( 3 ) ) / sin \hat{θ} , & ( 77 ) \\ [ Equation 217 ] & \\ \hat{u} = {[ c ( 4 ) , … , c ( 2 L + 4 ) ]}^{T} / sin \hat{θ} , and & ( 78 ) \\ [ Equation 218 ] & \\ {\hat{d}}_{Q} = \frac{2 ( c ( 2 ) - c ( 3 ) ) - ( c ( 1 ) - c ( 0 ) ) ( c ( 2 ) + c ( 3 ) )}{4 ( 1 - cos \hat{θ} ) ( c ( 4 ) + … + c ( 2 L + 4 ) )} & ( 79 )\end{matrix}$$
the method comprising the steps of:
determining that an absolute value of the hat θ is not zero;
downconverting a received signal;
determining a DIQ compensated signal having a real part and an imaginary part, the real part being an I axis compensated signal obtained by subtracting the hat d₁ from an I axis signal of the received signal and then operating the L-stage delay filter on the resulting signal, the imaginary part being a Q axis compensated signal obtained by subtracting the hat d_{Q} from a Q axis signal of the received signal, operating the vector u on the resulting signal, and then multiplying the I axis compensated signal by the hat λ; and
shifting a phase of the DIQ compensated signal by an inverted sign of the hat θ.

8. A method for compensating a received signal using the hat θ determined in claim 1, a hat λ, a hat d_{I}, a hat d_{IQ}, a vector hat u, and a hat d_{Q} determined, by
determining a hat λ (Equation 75),
determining a hat d_{I} (Equation 76),
determining a hat (Equation 77),
determining a vector hat u (Equation 78), and
determining a hat d_{Q} (Equation 79), where
$$\begin{matrix}[ Equation 214 ] & \\ \hat{λ} = 0.5 * ( c ( 1 ) - c ( 0 ) ) / sin \hat{θ} , & ( 75 ) \\ [ Equation 215 ] & \\ {\hat{d}}_{I} = 0.5 * ( c ( 2 ) + c ( 3 ) ) / ( 1 - cos \hat{θ} ) , & ( 76 ) \\ [ Equation 216 ] & \\ {\hat{d}}_{IQ} = 0.5 * ( c ( 2 ) - c ( 3 ) ) / sin \hat{θ} , & ( 77 ) \\ [ Equation 217 ] & \\ \hat{u} = {[ c ( 4 ) , … , c ( 2 L + 4 ) ]}^{T} / sin \hat{θ} , and & ( 78 ) \\ [ Equation 218 ] & \\ {\hat{d}}_{Q} = \frac{2 ( c ( 2 ) - c ( 3 ) ) - ( c ( 1 ) - c ( 0 ) ) ( c ( 2 ) + c ( 3 ) )}{4 ( 1 - cos \hat{θ} ) ( c ( 4 ) + … + c ( 2 L + 4 ) )} . & ( 79 )\end{matrix}$$
and an equalizer matrix E_{f}(m) determined by (Equation 42) from dot S₁(m), dot S ₁*1 (tick m), dot S₂(m), and dot S₂*(m) which are the R₁(m), the R₁*(tick m), the R₂(m), the R₂*(tick m), and transmitted data corresponding to the data, respectively, where
$$[ Equation 220 ]$$
$${E}_{f} ( m ) = {[ {[ \begin{matrix}{R}_{1} ( m ) & {R}_{2} ( m ) \\ {R}_{1}^{*} ( \breve{m} ) & {R}_{2}^{*} ( \breve{m} )\end{matrix} ] [ \begin{matrix}{\dot{S}}_{1} ( m ) & {\dot{S}}_{2} ( m ) \\ {\dot{S}}_{1}^{*} ( \breve{m} ) & {\dot{S}}_{2}^{*} ( \breve{m} )\end{matrix} ]}^{- 1} ]}^{- 1} \qquad ( 42 )$$
, the method comprising the steps of:
determining that an absolute value of the hat θ is not zero;
downconverting a received signal;
determining a DIQ compensated signal having a real part and an imaginary part, the real part being an I axis compensated signal obtained by subtracting the hat d_{I} from an I axis signal of the received signal and then operating the L-stage delay filter on the resulting signal, the imaginary part being a Q axis compensated signal obtained by subtracting the hat d_{Q} from a Q axis signal of the received signal, operating the vector u on the resulting signal, and then multiplying the I axis compensated signal by the hat λ;
shifting a phase of the DIQ compensated signal by an inverted sign of the hat θ;
DFT processing the phase shifted signal; and
obtaining a compensated signal hat dot S(m) and hat dot S(tick m) by operating the equalizer matrix E_{f}(m) on the mth and tick mth data (Equation 36) of the DFT processed data, where
[Equation 222]
\check{m}=[−m]_{N} (36).

9. A method for determining a compensation parameter, the compensation parameter compensating for a received signal having a pilot signal with a frequency domain portion in which K symbols are cyclically repeated, the method comprising the steps of:
acquiring N pieces of data starting at a sample acquisition start point in a Q axis signal of the frequency domain portion to create a vector a_{Q1} (Equation 88);
acquiring N pieces of data starting at a Kth piece of data from the sample acquisition start point in the Q axis signal of the frequency domain portion to create a vector a_{Q2} (Equation 89);
acquiring N+2L pieces of data starting at an Lth piece of data before the sample start point in an I axis signal of the frequency domain portion to create a matrix A_{I1} (Equation 90);
acquiring N+2L pieces of data starting at an (K−L)th piece of data after the sample start point in the Q axis signal of the frequency domain portion to create a matrix A_{I2} (Equation 91);
obtaining a matrix π (Equation 99) from the vector a_{I1} (Equation 88), the vector a_{Q2} (Equation 89), the matrix A_{I1} (Equation 90), the matrix A_{I2} (Equation 91), a vector 1 with N×1 elements being all unity, and a vector 0 with N×1 elements being all zero;
obtaining a matrix a_{Q} (Equation 100) from the vector a_{Q1} (Equation 88) and the vector a_{Q2} (Equation 89);
obtaining a vector c (Equation 101) from a pseudo-inverse matrix of the matrix π (Equation 99) and the matrix a_{Q} (Equation 100), where d_{I} is a real component of a DC offset (hereinafter referred to as a “DCO”) caused in a receiver and d_{Q} is an imaginary component, with the DCO being expressed as d_{QI} (Equation 92) from a vector u of (2L+1)×1 elements and a constant λ;
determining a CFO as a hat θ (Equation 102) from a first element (c(0)) and a second element (c(1)) of the vector c;
creating a matrix A (Equation 103) of N pieces of complex data, the N pieces of complex data starting at the sample start point in the frequency domain and arranged in M rows, with K pieces of complex data per row;
determining a matrix V (Equation 106) from a pseudo-inverse matrix of a matrix Θ(θ) (Equation 105), for which an absolute value of the hat θ is substituted, and the matrix A; and
determining that the hat θ has a positive sign if a power of a first column of the matrix V (Equation 106) is greater than a power of a second column, and otherwise determining that the hat θ has a negative sign, where
$$\begin{matrix} [ Equation 223 ] & \\ {a}_{Q 1} = {[ {a}_{Q} ( n ) , … , {a}_{Q} ( n + N - 1 ) ]}^{T} , & ( 88 ) \\ [ Equation 224 ] & \\ {a}_{Q 2} = {[ {a}_{Q} ( n + K ) , … , {a}_{Q} ( n + K + N - 1 ) ]}^{T} , & ( 89 ) \\ [ Equation 225 ] & \\ {A}_{I 1} = [ \begin{matrix}{a}_{I} ( n + L ) & … & {a}_{I} ( n - L ) \\ {a}_{I} ( n + 1 + L ) & … & {a}_{I} ( n + 1 - L ) \\ ⋮ & ⋮ & ⋮ \\ {a}_{I} ( n + N - 1 + L ) & … & {a}_{I} ( n + N - 1 - L )\end{matrix} ] , & ( 90 ) \\ [ Equation 226 ] & \\ {A}_{I 2} = [ \begin{matrix}{a}_{I} ( n + K + L ) & … & {a}_{I} ( n + K - L ) \\ {a}_{I} ( n + K + 1 + L ) & … & {a}_{I} ( n + K + 1 - L ) \\ ⋮ & ⋮ & ⋮ \\ {a}_{I} ( n + K + N - 1 + L ) & … & {a}_{I} ( n + K + N - 1 - L )\end{matrix} ] , & ( 91 ) \\ [ Equation 227 ] & \\ Π = [ \begin{matrix}{a}_{Q 2} & 0 & 1 & 0 & - {A}_{I 2} \\ 0 & {a}_{Q 1} & 0 & 1 & {A}_{I 1}\end{matrix} ] , & ( 99 ) \\ [ Equation 228 ] & \\ {a}_{Q} = [ \begin{matrix}{a}_{Q 1} \\ {A}_{Q 2}\end{matrix} ] , & ( 100 ) \\ [ Equation 229 ] & \\ {d}_{QI} = {d}_{I} {\sum }_{l = 0}^{2 L} {u}_{l} + λ {d}_{Q} , & ( 92 ) \\ [ Equation 230 ] & \\ c = {Π}^{†} {a}_{Q} = [ \begin{matrix}cos θ - λsin θ \\ cos θ + λsin θ \\ {d}_{Q} ( 1 - cos θ ) + {d}_{QI} sin θ \\ {d}_{Q} ( 1 - cos θ ) - {d}_{QI} sin θ \\ u sin θ\end{matrix} ] , & ( 101 ) \\ [ Equation 231 ] & \\ \hat{θ} = arc cos \{ 0.5 * ( c ( 0 ) + c ( 1 ) ) \} , & ( 102 ) \\ [ Equation 232 ] & \\ A = [ \begin{matrix}a ( n ) & … & a ( n + K - 1 ) \\ a ( n + K ) & … & a ( n + 2 K - 1 ) \\ ⋮ & ⋮ & ⋮ \\ a ( n + N - K ) & … & a ( n + N - 1 )\end{matrix} ] , & ( 103 ) \\ [ Equation 233 ] & \\ Θ ( θ ) = [ \begin{matrix}1 & 1 & 1 \\ {e}^{jθ} & {e}^{- j θ} & 1 \\ ⋮ & ⋮ & ⋮ \\ {e}^{j ( M - 1 ) θ} & {e}^{- j ( M - 1 ) θ} & 1\end{matrix} ] , and & ( 105 ) \\ [ Equation 234 ] & \\ V = {Θ}^{†} ( \vert \hat{θ} \vert ) A . & ( 106 )\end{matrix}$$

10. The method for determining a compensation parameter according to claim 9, wherein the hat θ has a sufficiently small absolute value, and the pilot signal further includes at least a first and a second frequency domain portion in which known data is transmitted, and the method further comprises the steps of:
DFT processing the first frequency domain portion;
determining R₁*(tick m) which is conjugate data of mth data R₁(m) and tick mth data (Equation 36) of the DFT processed data;
DFT processing the second frequency domain portion;
determining R₂*(tick m) which is conjugate data of mth data R₂(m) and tick mth data (Equation 36) of the DFT processed data; and
determining an equalizer matrix E₁(m) (Equation 42) from dot S₁(m), dot S₁*1 (tick m), dot S₂(m), and dot S₂*(m) which are the R₁(m), the R₁*(tick m), the R₂(m), the R₂*(tick m), and transmitted data corresponding to the data, respectively, where
$$\begin{matrix}[ Equation 235 ] & \\ \breve{m} = {[ - m ]}_{N} , and & ( 36 ) \\ [ Equation 236 ] & \\ {E}_{f} ( m ) = {[ {[ \begin{matrix}{R}_{1} ( m ) & {R}_{2} ( m ) \\ {R}_{1}^{*} ( \breve{m} ) & {R}_{2}^{*} ( \breve{m} )\end{matrix} ] [ \begin{matrix}{\dot{S}}_{1} ( m ) & {\dot{S}}_{2} ( m ) \\ {\dot{S}}_{1}^{*} ( \breve{m} ) & {\dot{S}}_{2}^{*} ( \breve{m} )\end{matrix} ]}^{- 1} ]}^{- 1} . & ( 42 )\end{matrix}$$

11. The method for determining a compensation parameter according to claim 9, the compensation parameter compensating for a received signal having a pilot signal with a frequency domain portion in which K symbols are cyclically repeated, the method further comprising the steps of: from the hat θ and the vector c,
determining a hat λ (Equation 109),
determining a hat d_{I} (Equation 110),
determining a hat d_{IQ} (Equation 111),
determining a vector hat u (Equation 112), and
determining a hat d_{Q} (Equation 113), where
$$\begin{matrix}[ Equation 237 ] & \\ \hat{λ} = 0.5 * ( c ( 1 ) - c ( 0 ) ) / sin \hat{θ} , & ( 109 ) \\ [ Equation 238 ] & \\ {\hat{d}}_{I} = 0.5 * ( c ( 2 ) + c ( 3 ) ) / ( 1 - cos \hat{θ} ) , & ( 110 ) \\ [ Equation 239 ] & \\ {\hat{d}}_{QI} = 0.5 * ( c ( 2 ) - c ( 3 ) ) / sin \hat{θ} , & ( 111 ) \\ [ Equation 240 ] & \\ \hat{u} = {[ c ( 4 ) , … , c ( 2 L + 4 ) ]}^{T} / sin \hat{θ} , and & ( 112 ) \\ [ Equation 241 ] & \\ {\hat{d}}_{Q} = \frac{2 ( c ( 2 ) - c ( 3 ) ) - ( c ( 1 ) - c ( 0 ) ) ( c ( 2 ) + c ( 3 ) )}{4 ( 1 - cos \hat{θ} ) ( c ( 4 ) + … + c ( 2 L + 4 ) )} . & ( 113 )\end{matrix}$$

12. The method for determining a compensation parameter according to claim 10, wherein the pilot signal further includes at least a first frequency domain portion and a second frequency domain portion in which known data is transmitted, and the method further comprises the steps of:
determining a first DIQ compensated signal having an imaginary part and a real part, the imaginary part being a first Q axis compensated signal obtained by subtracting the hat d_{Q} from a Q axis signal of the first frequency domain portion and then operating the L-stage delay filter on the resulting signal, the real part being a first I axis compensated signal obtained by subtracting the hat d_{I} from an I axis signal of the first frequency domain portion, operating the vector u on the resulting signal, and then multiplying the first Q axis compensated signal by the hat λ;
shifting a phase of the first DIQ compensated signal by an inverted sign of the hat θ to determine a first internal interference compensation signal;
DFT processing the first internal interference compensation signal;
determining an R₁*(tick m) which is conjugate data of mth data R₁(m) and tick mth data (Equation 36) of the DFT processed data;
determining a second DIQ compensated signal having an imaginary part and a real part, the imaginary part being a second Q axis compensated signal obtained by subtracting the hat d_{Q} from a Q axis signal of the second frequency domain portion, and then operating the L-stage delay filter on the resulting signal, the real part being a second I axis compensated signal obtained by subtracting the hat d_{I} from an I axis signal of the second frequency domain portion, operating the vector u on the resulting signal, and then multiplying the second Q axis compensated signal by the hat λ;
shifting a phase of the second DIQ compensated signal by an inverted sign of the hat θ to determine a second internal interference compensation signal;
DFT processing the internal interference compensation signal;
determining an R₂*(tick m) which is conjugate data of mth data R₂(m) and tick mth data (Equation 36) of the DFT processed data; and
determining an equalizer matrix E_{f}(m) (Equation 42) from dot S₁(m), dot S₁*1 (tick m), dot S₂(m), and dot S₂*(m) which are the R₁(m), the R₁*(tick m), the R₂(m), the R₂*(tick m), and transmitted data corresponding to the data, respectively, where
$$\begin{matrix}[ Equation 242 ] & \\ \breve{m} = {[ - m ]}_{N} , and & ( 36 ) \\ [ Equation 243 ] & \\ {E}_{f} ( m ) = {[ {[ \begin{matrix}{R}_{1} ( m ) & {R}_{2} ( m ) \\ {R}_{1}^{*} ( \breve{m} ) & {R}_{2}^{*} ( \breve{m} )\end{matrix} ] [ \begin{matrix}{\dot{S}}_{1} ( m ) & {\dot{S}}_{2} ( m ) \\ {\dot{S}}_{1}^{*} ( \breve{m} ) & {\dot{S}}_{2}^{*} ( \breve{m} )\end{matrix} ]}^{- 1} ]}^{- 1} . & ( 42 )\end{matrix}$$

13. A method for compensating a received signal using the hat θ determined in claim 9, the method comprising the steps of:
downconverting a received signal; and
shifting a phase of the downconverted signal by an inverted sign of the hat θ.

14. A method for compensating a received signal using the hat θ determined in claim 9 and an equalizer matrix E_{f}(m) determined by (Equation 42) from dot S₁ (m), dot S₁*1 (tick m), dot S₂(m), and dot S₂*(m) which are the R₁(m), the R₁*(tick m), the R₂(m), the R₂*(tick m), and transmitted data corresponding to the data, respectively, where
$$[ Equation 236 ]$$
$${E}_{f} ( m ) = {[ {[ \begin{matrix}{R}_{1} ( m ) & {R}_{2} ( m ) \\ {R}_{1}^{*} ( \breve{m} ) & {R}_{2}^{*} ( \breve{m} )\end{matrix} ] [ \begin{matrix}{\dot{S}}_{1} ( m ) & {\dot{S}}_{2} ( m ) \\ {\dot{S}}_{1}^{*} ( \breve{m} ) & {\dot{S}}_{2}^{*} ( \breve{m} )\end{matrix} ]}^{- 1} ]}^{- 1} , \qquad ( 42 )$$
the method comprising the steps of:
determining that an absolute value of the hat θ is generally zero;
downconverting a received signal;
shifting a phase of the downconverted signal by an inverted sign of the hat θ;
DFT processing the phase shifted signal; and
obtaining a compensated signal hat dot S(m) and hat dot S(tick m) by operating the equalizer matrix E_{f}(m) on the mth and the tick mth data (Equation 36) of the DFT processed data, where
[Equation 244]
\check{m}=[−m]_{N} (36).

15. A method for compensating a received signal using the hat θ determined in claim 9, and a hat λ, a hat d_{I}, a hat d_{QI}, a vector hat u, and a hat d_{Q} determined by,
determining a hat λ (Equation 109),
determining a hat d_{I} (Equation 110),
determining a hat d_{IQ} (Equation 111),
determining a vector hat u (Equation 112), and
determining a hat d_{Q} (Equation 113), where
$$\begin{matrix}[ Equation 237 ] & \\ \hat{λ} = 0.5 * ( c ( 1 ) - c ( 0 ) ) / sin \hat{θ} , & ( 109 ) \\ [ Equation 238 ] & \\ {\hat{d}}_{I} = 0.5 * ( c ( 2 ) + c ( 3 ) ) / ( 1 - cos \hat{θ} ) , & ( 110 ) \\ [ Equation 239 ] & \\ {\hat{d}}_{QI} = 0.5 * ( c ( 2 ) - c ( 3 ) ) / sin \hat{θ} , & ( 111 ) \\ [ Equation 240 ] & \\ \hat{u} = {[ c ( 4 ) , … , c ( 2 L + 4 ) ]}^{T} / sin \hat{θ} , and & ( 112 ) \\ [ Equation 241 ] & \\ {\hat{d}}_{Q} = \frac{2 ( c ( 2 ) - c ( 3 ) ) - ( c ( 1 ) - c ( 0 ) ) ( c ( 2 ) + c ( 3 ) )}{4 ( 1 - cos \hat{θ} ) ( c ( 4 ) + … + c ( 2 L + 4 ) )} & ( 113 )\end{matrix}$$
the method comprising the steps of:
determining that an absolute value of the hat θ is not zero;
downconverting a received signal;
determining a DIQ compensated signal having an imaginary part and a real part, the imaginary part being a Q axis compensated signal obtained by subtracting the hat d_{Q} from a Q axis signal of the received signal, and then operating the L-stage delay filter on the resulting signal, the real part being an I axis compensated signal obtained by subtracting the hat d_{I} from an I axis signal of the received signal, operating the vector u on the resulting signal, and then adding the Q axis compensated signal multiplied by the hat λ to the resulting signal; and
shifting a phase of the DIQ compensated signal by an inverted sign of the hat θ.

16. A method for compensating a received signal using the hat θ determined in claim 9, a hat λ, a hat d_{I}, a hat d_{IQ}, a vector hat u, and a hat d_{Q} determined by
determining a hat λ (Equation 109),
determining a hat d_{I} (Equation 110),
determining a hat d_{IQ} (Equation 111),
determining a vector hat u (Equation 112), and
determining a hat d_{Q} (Equation 113), where
$$\begin{matrix}[ Equation 237 ] & \\ \hat{λ} = 0.5 * ( c ( 1 ) - c ( 0 ) ) / sin \hat{θ} , & ( 109 ) \\ [ Equation 238 ] & \\ {\hat{d}}_{I} = 0.5 * ( c ( 2 ) + c ( 3 ) ) / ( 1 - cos \hat{θ} ) , & ( 110 ) \\ [ Equation 239 ] & \\ {\hat{d}}_{QI} = 0.5 * ( c ( 2 ) - c ( 3 ) ) / sin \hat{θ} , & ( 111 ) \\ [ Equation 240 ] & \\ \hat{u} = {[ c ( 4 ) , … , c ( 2 L + 4 ) ]}^{T} / sin \hat{θ} , and & ( 112 ) \\ [ Equation 241 ] & \\ {\hat{d}}_{Q} = \frac{2 ( c ( 2 ) - c ( 3 ) ) - ( c ( 1 ) - c ( 0 ) ) ( c ( 2 ) + c ( 3 ) )}{4 ( 1 - cos \hat{θ} ) ( c ( 4 ) + … + c ( 2 L + 4 ) )} . & ( 113 )\end{matrix}$$
and the equalizer matrix E₁(m) determined by (Equation 42) from dot S₁(m), dot S₁*1 (tick m), dot S₂(m), and dot S₂*(m) which are the R₁ (m), the R₁*(tick m), the R₂(m), the R₂*(tick m), and transmitted data corresponding to the data, respectively, where
$$[ Equation 243 ]$$
$${E}_{f} ( m ) = {[ {[ \begin{matrix}{R}_{1} ( m ) & {R}_{2} ( m ) \\ {R}_{1}^{*} ( \breve{m} ) & {R}_{2}^{*} ( \breve{m} )\end{matrix} ] [ \begin{matrix}{\dot{S}}_{1} ( m ) & {\dot{S}}_{2} ( m ) \\ {\dot{S}}_{1}^{*} ( \breve{m} ) & {\dot{S}}_{2}^{*} ( \breve{m} )\end{matrix} ]}^{- 1} ]}^{- 1} , \qquad ( 42 )$$
the method comprising the steps of:
determining that an absolute value of the hat θ is not zero;
downconverting a received signal;
determining a DIQ compensated signal having a first real part and a second real part, the first real part being a Q axis compensated signal obtained by subtracting the hat d_{Q} from a Q axis signal of the received signal and then operating the L-stage delay filter on the resulting signal, the second real part being
an I axis compensated signal obtained by subtracting the hat d_{I} from an I axis signal of the received signal, operating the vector u on the resulting signal, and then adding the Q axis compensated signal multiplied by the hat λ to the resulting signal;
shifting a phase of the DIQ compensated signal by an inverted sign of the hat θ;
DFT processing the phase shifted signal; and
obtaining a compensated signal hat dot S(m) and hat dot S(tick m) by operating the equalizer matrix E_{f}(m) on the mth and the tick mth data (Equation 36) of the DFT processed data, where
[Equation 245]
\check{m}=[−m]_{N} (36).

17. (canceled)

18. (canceled)

19. (canceled)
